(19) United States
(12) Patent Application Publication
(10) Pub. No.: US 2023/0019267 A1
(43) Pub. Date: Jan. 19, 2023

(54) SYSTEM TO DELIVER A SOLUTION WITH A BIOLOGICAL PRODUCT IN A PLANTER ASSEMBLY

(71) Applicant: Pivot Bio, Inc., Berkeley, CA (US)

(72) Inventors: Dennis Hapes, Berkeley, CA (US); Mark Reisinger, Berkeley, CA (US); Adam Holm, Berkeley, CA (US)

(73) Assignee: Pivot Bio, Inc., Berkeley, CA (US)

(21) Appl. No.: 17/782,502

(22) PCT Filed: Dec. 2, 2020
(86) PCT No.: PCT/US2020/062875

§ 371 Date: Jun. 3, 2022

Related U.S. Application Data
(60) Provisional application No. 62/943,671, filed on Dec. 4, 2019.

(51) Int. Cl. A01C 23/00; A01C 23/02; A01C 7/06

(52) U.S. Cl. CPC A01C 23/007; A01C 23/023; A01C 7/06

(57) ABSTRACT

Systems for delivering biological products are provided. The biological products may be delivered, for example, to a field. The systems may include a container (110, 210, 310) for holding the biological product. The systems may also include a fluid flow unit (120, 220, 320) configured to subject the biological product to flow from within the container along a fluid flow path (115, 215, 315). Methods of delivering biological products are also provided.

### CROSS-REFERENCE TO RELATED APPLICATIONS

This application claims priority to U.S. Application Ser. No. 62/943,671, filed on Dec. 4, 2019, the entirety of which is herein incorporated by reference.

### BACKGROUND

Various substances may be applied to a field, including, for example, seeds, fertilizers, nutrients, pesticides, and water. Equipment such as tractors and planting assemblies may be used to deliver and/or apply one or more substances to a field. Economically, environmentally, and socially sustainable approaches to agriculture and food production may require changes to current farming practices so that food production may meet the needs of a growing global population. By 2050 the United Nations' Food and Agriculture Organization projects that total food production must increase by 70% to meet the needs of the growing population, a challenge that is exacerbated by numerous factors, including diminishing freshwater resources, increasing competition for arable land, rising energy prices, increasing input costs, and the likely need for crops to adapt to the pressures of a drier, hotter, and more extreme global climate.

One area of interest is in the improvement in the way nitrogen is provided to crops such as through the improvement of biological nitrogen fixation. Nitrogen gas (N₂) is a major component of the atmosphere of Earth. In addition, elemental nitrogen (N) is an important component of many chemical compounds which make up living organisms. However, many organisms cannot use N₂ directly to synthesize the chemicals used in physiological processes, such as growth and reproduction. In order to utilize the N₂, the N₂ is combined with hydrogen. The combining of hydrogen with N₂ is referred to as nitrogen fixation. Nitrogen fixation, whether accomplished chemically or biologically, requires an investment of large amounts of energy. While recent developments have allowed for the provision of nitrogen to crops through nitrogen-fixing microorganisms, delivery of these and other beneficial microorganisms to crop plants can be improved.

### SUMMARY

In some embodiments, the present disclosure provides a system to deliver a biological product, the system comprising: a first container configured to contain a first solution comprising the biological product; a first fluid flow path, wherein the first fluid flow path is in fluid communication with the first container; and at least one fluid flow unit configured to subject the first solution to flow from the first container along the first fluid flow path. In some cases, the first fluid flow path is couplable to a planting assembly. In some cases, the system is configured to deliver the first solution to the planting assembly. In some cases, a portion of the system is configured to be disposed on the planting assembly. In some cases, the planting assembly is configured to dispose the first solution into a field. In some cases, the system further comprises a first valve disposed along the first fluid flow path. In some cases, the first valve is a one-way valve. In some cases, the first valve is configured to allow flow of the first solution in a first direction and inhibit flow of the first solution in a second direction, wherein the first direction is distal to the first container, and wherein the second direction is proximal to the first container. In some cases, the first valve inhibits contamination of the first container. In some cases, the at least one fluid flow unit is configured to vary a flow rate of the first solution based on a speed of the system relative to a field. In some cases, the system further comprises a first flowmeter configured to detect the flow rate of the first solution through a portion of the first fluid flow path.

In some cases, the at least one fluid flow unit is operably coupled to a speed reader, wherein the speed reader is configured to detect the speed of the system relative to the field. In some cases, the at least one fluid flow unit is operably coupled to the first flowmeter. In some cases, the at least one fluid flow unit is a first pump. In some cases, a rate of the first pump is configured to be varied based on the speed of the system relative to the field. In some cases, a capacity of the first pump is from 0.05 gallon per minute to 2.5 gallons per minute. In some cases, the system further comprises a controller operably coupled to the at least one fluid flow unit, the first flowmeter, and the speed reader, wherein the controller is configured to adjust a delivery rate of the first solution to the field. In some cases, the delivery rate of the first solution is from 0.05 gallon per acre to 1 gallon per acre. In some cases, a volume of the first container is from 20 gallons to 60 gallons. In some cases, the volume of the first container is from 30 gallons to 50 gallons. In some cases, the first container consists essentially of the first solution and the first solution consists essentially of the biological product. In some cases, the biological product is selected from the group consisting of nitrogen-fixing microbes, phosphate-solubilizing microbes, and any combination thereof.

In other embodiments, the present disclosure provides a system to deliver a biological product, comprising: a first container configured to contain a first solution comprising the biological product; a second container configured to contain a second solution; a first fluid flow path, a second fluid flow path, and a third fluid flow path, wherein the first fluid flow path and the second fluid flow path meet at an intersection, and wherein the first fluid flow path is in fluid communication with the first container and the second fluid flow path is in fluid communication with the second container; and at least one fluid flow unit configured to subject (i) the first solution to flow from the first container along the first fluid flow path to the intersection and (ii) the second solution to flow from the second container along the second fluid flow path to the intersection, to yield a mixture of the first solution and the second solution at the intersection, which mixture flows along the third fluid flow path. In some cases, the third fluid flow path is couplable to a planting assembly. In some cases, the system is configured to deliver the mixture to the planting assembly. In some cases, a portion of the system is configured to be disposed on the planting assembly. In some cases, the planting assembly is configured to dispose the mixture into a field.

In some cases, the system further comprises a first valve disposed between the first container In some cases, the first valve is configured to allow flow of the first solution in a first direction and inhibit flow of the first solution in a second direction, wherein the first direction is distal to the first container, and wherein the second direction is proximal to the first container. In some cases, the first valve inhibits contamination of the first container by the second solution.

In some cases, the system further comprises a second valve disposed between the second container and the intersection. In some cases, the second valve is a one-way valve. In some cases, the second valve is configured to allow flow of the second solution in a first direction and inhibit flow of the second solution in a second direction, wherein the first direction is distal to the second container, and wherein the second direction is proximal to the second container. In some cases, the second valve inhibits contamination of the second container by the first solution. In some cases, the at least one fluid flow unit is configured to vary a first flow rate of the first solution based on a speed of the system relative to a field. In some cases, the system further comprises a first flowmeter configured to detect the first flow rate of the first solution through a portion of the first fluid flow path. In some cases, the at least one fluid flow unit is operably coupled to a speed reader, wherein the speed reader is configured to detect the speed of the system relative to the field. In some cases, the at least one fluid flow unit is a first fluid flow unit operably coupled to the first flowmeter. In some cases, the first fluid flow unit is a first pump. In some cases, a rate of the first pump is configured to be varied based on the speed of the system relative to the field. In some cases, a capacity of the first pump is from 0.05 gallons per minute to 2.5 gallons per minute. In some cases, the at least one fluid flow unit comprises a plurality of fluid flow units, wherein a second fluid flow unit is configured to vary a second flow rate of the second solution based on a speed of the system relative to the field.

In some cases, the system further comprises a second flowmeter configured to detect the flow rate of the second solution through a portion of the second fluid flow path. In some cases, the second fluid flow unit is operably coupled to a speed reader, wherein the speed reader is configured to detect the speed of the system relative to the field. In some cases, the second fluid flow unit is operably coupled to the second flowmeter. In some cases, the second fluid flow unit is a second pump. In some cases, a rate of the second pump is configured to be varied based on the speed of the system relative to the field. In some cases, a capacity of the second pump is from 3 gallons per minute to 7.5 gallons per minute. In some cases, the system further comprises a controller operably coupled to the first pump, the second pump, the first flowmeter, the second flowmeter, and the speed reader, wherein the controller is configured to adjust a delivery rate of the mixture to the field. In some cases, the delivery rate of the mixture is from 3 gallons per acre to 5 gallons per acre. In some cases, the first container consists essentially of the first solution and the first solution consists essentially of the biological product. In some cases, the biological product is selected from the group consisting of nitrogen-fixing microbes, phosphate-solubilizing microbes, and any combination thereof.

In further embodiments, the present disclosure provides a method for delivering a biological product, the method comprising: providing a first fluid flow path, wherein the first fluid flow path is in fluid communication with a first container containing a first solution comprising the biological product; and subjecting the first solution to flow from the first container along the first fluid flow path. In some cases, the method further comprises coupling the first fluid flow path to a planting assembly. In some cases, the method further comprises applying the first solution to a field via the planting assembly at a rate of less than one-fifth gallon per acre. In some cases, the method further comprises activating at least one fluid flow unit to subject the first solution to flow from the first container along the first fluid flow path. In some cases, the at least one fluid flow unit is a first pump. In some cases, the method further comprises adjusting a rate of the first pump based on a speed of the planting assembly relative to the field. In some cases, the rate of the first pump is increased as the speed of the planting assembly increases, and the rate of the first pump is decreased as the speed of the planting assembly decreases.

In some cases, the method further comprises adjusting a rate of the first pump based on a width of the planting assembly. In some cases, the biological product is selected from the group consisting of nitrogen-fixing microbes, phosphate-solubilizing microbes, or a combination thereof. In some embodiments the present disclosure provides a method for delivering a biological product, comprising: providing a first fluid flow path, a second fluid flow path, and a third fluid flow path, wherein the first fluid flow path and the second fluid flow path meet at an intersection, and wherein the first fluid flow path is in fluid communication with a first container containing a first solution comprising the biological product and the second fluid flow path is in fluid communication with a second container containing a second solution; and subjecting (i) the first solution to flow from the first container along the first fluid flow path to the intersection and (ii) the second solution to flow from the second container along the second fluid flow path to the intersection, to yield a mixture of the first solution and the second solution at the intersection, which mixture flows along the third fluid flow path. In some cases, the method further comprises coupling the third fluid flow path to a planting assembly.

In some cases, the method further comprises applying the mixture to a field via the planting assembly at a rate of from three to five gallons per acre. In some cases, the first solution is mixed with the second solution less than 5 minutes prior to application of the mixture to the field. In some cases, the method further comprises activating at least one fluid flow unit to subject (i) the first solution to flow from the first container along the first fluid flow path to the intersection and (ii) the second solution to flow from the second container along the second fluid flow path to the intersection. In some cases, the at least one fluid flow unit comprises a first pump and a second pump. In some cases, the method further comprises adjusting a rate of the at least one fluid flow unit based on a speed of the planting assembly relative to the field. In some cases, the rate of the at least one fluid flow unit is increased as the speed of the planting assembly increases, and the rate of the at least one fluid flow unit is decreased as the speed of the planting assembly decreases. In some cases, the method further comprises adjusting a rate of the at least one fluid flow unit based on a width of the planting assembly. In some cases, the biological product is selected from the group consisting of nitrogen-fixing microbes, phosphate-solubilizing microbes, or a combination thereof. In some cases, the second solution comprises water, fertilizer, nutrients, or a combination thereof.

In some embodiments the present disclosure provides an apparatus, comprising: a biological container configured to retain a biological product; an adapter configured to couple the biological container to a planting assembly; a first fluid flow unit configured to subject contents from within the biological container to flow toward the adapter; a first flowmeter configured to detect a first flow rate of the contents from within the biological container; a first one-way valve couplable to a first portion of the adapter; and a controller operatively coupled to the first fluid flow unit and the first flowmeter, wherein the controller is configured to (i) measure the first flow rate of the contents from within the biological container and (ii) direct the first fluid flow unit to regulate the first flow rate against a setpoint flow rate.

In some cases, a portion of the apparatus is configured to be disposed on the planting assembly. In some cases, the planting assembly is configured to dispose the contents from within the biological container into a field. In some cases, the first one-way valve is configured to allow flow of the contents from within the biological container in a first direction and inhibit flow of the contents from within the biological container in a second direction, wherein the first direction is distal to the biological container, and wherein the second direction is proximal to the biological container. In some cases, the first one-way valve inhibits contamination of the biological container. In some cases, the first fluid flow unit is configured to vary the first flow rate based on a speed of the apparatus relative to a field. In some cases, the first fluid flow unit is operably coupled to a speed reader, wherein the speed reader is configured to detect the speed of the apparatus relative to the field. In some cases, the first fluid flow unit is operably coupled to the first flowmeter. In some cases, the first fluid flow unit is a first pump. In some cases, a rate of the first pump is configured to be varied based on the speed of the apparatus relative to the field. In some cases, a capacity of the first pump is from 0.05 gallons per minute to 2.5 gallons per minute.

In some cases, the apparatus further comprises: a second container; a second fluid flow unit configured to subject contents from within the second container to flow toward the adapter; a second flowmeter configured to detect a second flow rate of the contents from within the second container; and a second one-way valve couplable to a second portion of the adapter; wherein the controller is further operatively coupled to the second flowmeter and the second fluid flow unit, wherein the controller is further configured to (iii) measure the second flow rate of the contents from within the second container and (iv) direct the second fluid flow unit to regulate the second flow rate against a setpoint flow rate. In some cases, the contents from within the biological container and the contents from within the second container yield a mixture at the adapter, which mixture flows along a third fluid flow path. In some cases, the planting assembly is configured to dispose the mixture into the field. In some cases, the first one-way valve inhibits contamination of the biological container by the contents from within the second container. In some cases, the second one-way valve is configured to allow flow of the contents from within the second container in a first direction and inhibit flow of the contents from within the second container in a second direction, wherein the first direction is distal to the second container, and wherein the second direction is proximal to the second container. In some cases, the second one-way valve inhibits contamination of the second container by the contents from within the biological container. In some cases, the second fluid flow unit is configured to vary a second flow rate of the contents from within the second container based on the speed of the apparatus relative to the field. In some cases, the second fluid flow unit is operably coupled to the speed reader.

In some cases, the second fluid flow unit is operably coupled to the second flowmeter. In some cases, the second fluid flow unit is a second pump. In some cases, a rate of the second pump is configured to be varied based on the speed of the apparatus relative to the field. In some cases, a capacity of the second pump is from 3 gallons per minute to 10 gallons per minute. In some cases, the biological container consists essentially of the biological product. In some cases, the biological product is selected from the group consisting of nitrogen-fixing microbes, phosphate-solubilizing microbes, and any combination thereof.

In other embodiments, the present disclosure provides a fluid dispensing apparatus for farming, the apparatus comprising: a biological container configured to retain a biological product; a mounting mechanism configured to couple the biological container to a planting assembly; a pump configured to subject contents from within the biological container to flow toward the mounting mechanism; a plurality of one-way valves couplable to a first portion of the mounting mechanism; a plurality of first hoses connecting the biological container to a first side of the plurality of one-way valves; a plurality of second hoses configured to connect a second side of the plurality of one-way valves to supply lines of the planting assembly, wherein the contents from within the biological container flow, based on actuation of the pump, through (i) the plurality of first hoses, (ii) the plurality of one-way valves, and (iii) the plurality of second hoses to the supply lines of the planting assembly; a local power source couplable to a second portion of the mounting mechanism and configured to power at least the pump; and a switch couplable to the biological container and configured to, when actuated, activate the local power source.

In some cases, the apparatus further comprises a controller couplable to a third portion of the mounting mechanism, wherein the controller is configured to: determine a speed at which to move the planting assembly in a field; determine, based on the speed, a pressure level to release the contents from within the biological container; actuate, based on the pressure level, the pump to subject the contents from within the biological container to flow through (i) the plurality of first hoses, (ii) the plurality of one-way valves, and (iii) the plurality of second hoses to the supply lines of the planting assembly.

In some cases, a subset of the plurality of one-way valves can be opened to correspond to a quantity of the supply lines of the planting assembly. In some cases, a portion of the apparatus is configured to be disposed on the planting assembly. In some cases, the planting assembly is configured to dispose the contents from within the biological container into a field. In some cases, the plurality of one-way valves is configured to allow flow of the contents from within the biological container in a first direction and inhibit flow of the contents from within the biological container in a second direction, wherein the first direction is distal to the biological container, and wherein the second direction is proximal to the biological container. In some cases, the pump is operably coupled to a sensor, wherein the sensor is couplable to a portion of the apparatus and configured to detect a speed of the apparatus relative to the field.

In some cases, the controller is further configured to: determine that the speed of the apparatus relative to the field exceeds a threshold value relative to the pressure level for actuating the pump; and generate a notification prompting a user to reduce a speed of the planting assembly from (i) the speed of the apparatus relative to the field to (ii) the determined speed at which to move the planting assembly in the field. In some cases, the sensor is an accelerometer. In some cases, the local power source is a rechargeable battery. In some cases, the switch is actuated using a key fob. In some cases, the switch is wireless. In some cases, the mounting mechanism is configured to hang over a railing of the planting assembly. In some cases, the apparatus further comprises a universal mount couplable to the planting assembly and configured to couple the mounting mechanism of the apparatus to the planting assembly.

In other embodiments, the present disclosure provides a method for installing a fluid dispensing apparatus to a planting assembly, the method comprising: charging a local power source of the apparatus; mounting the apparatus to a portion of the planting assembly, wherein the apparatus includes a mounting mechanism that is couplable to the planting assembly; coupling first ends of a plurality of hoses to a plurality of one-way valves, wherein the plurality of one-way valves are configured to the mounting mechanism; coupling second ends opposite the first ends of the plurality of hoses to a plurality of supply lines of the planting assembly; filling a biological container of the apparatus with a biological product; and actuating a switch of the apparatus, wherein actuating the switch causes a pump of the apparatus to subject contents from within the biological container to flow from the biological container, through (i) the plurality of one-way valves and (ii) the plurality of hoses, and into the supply lines of the planting assembly.

In some cases, mounting the apparatus to a portion of the planting assembly comprises hanging the apparatus over a rail of the planting assembly. In some cases, charging a local power source comprises at least one of charging a rechargeable battery and charging one or more solar panels. In some cases, the method further comprises coupling the first ends of the plurality of hoses to a subset of the plurality of one-way valves, wherein the subset of the plurality of one-way valves corresponds to a quantity of the supply lines of the planting assembly. In some cases, actuating a switch comprises swiping a key fob over the switch, wherein the switch is couplable to a portion of the apparatus.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a process flow diagram of an embodiment of a system for delivering a biological product.

FIG. 2 is a process flow diagram of another embodiment of a system for delivering a biological product.

FIG. 3A is a rear perspective view of a portion of another embodiment of a system for delivering a biological product, wherein the system is coupled to a tractor.

FIG. 3B is a rear perspective view of another portion of the system of FIG. 3A.

FIG. 3C is a front perspective view of another portion of the system of FIG. 3A.

FIG. 3D is a rear perspective view of another portion of the system of FIG. 3A.

FIG. 3E is a front perspective view of another portion of the system of FIG. 3A.

FIG. 4 is a block diagram of another embodiment of a system for delivering a biological product.

FIG. 5 is a side perspective view of a system having the self-contained liquid system of FIG. 4.

FIG. 6A is a side view of a system of FIG. 5.

FIG. 6B is a perspective view of the system of FIG. 5.

FIG. 6C is a top down view of the system of FIG. 5.

FIG. 7 is a rear perspective view of a portion of the system of FIG. 4.

FIG. 8 is a side perspective view of another portion of the system of FIG. 4.

FIG. 9 is a rear perspective view of the system of FIG. 4.

FIG. 10 is a flowchart of a process for installing and preparing the system of FIG. 4.

FIG. 11 is a flowchart of a process for using the system of FIG. 4.

### DETAILED DESCRIPTION

### Introduction

Systems for delivering biological products to a field are disclosed herein, along with related methods. Biological products may be used to improve plant growth, for example, to improve crop growth. In some cases, a biological product may improve plant growth by increasing the availability of nutrients; providing plant growth hormones; and/or providing protection against pests, salinity, drought, and/or temperature extremes. In some cases, a biological product may increase availability of a nutrient, for example, nitrogen or phosphorous. A biological product may increase nitrogen availability by fixing atmospheric nitrogen to produce ammonia or glutamate. A biological product may increase phosphorous availability by solubilizing insoluble soil phosphates.

The system may deliver the biological product to a seed of a plant crop or the system may deliver the biological product to a furrow (e.g., in a field) where a seed is planted. The seed may be disposed in the field prior to the biological product. In some embodiments, the biological product may be disposed in the field prior to the seed. In some other embodiments, the seed and the biological product may be disposed in the field substantially simultaneously. In certain embodiments, the biological product may be disposed in the field multiple times, for example, both substantially simultaneously with a seed and subsequently to the seed. In some cases, the biological product may be disposed in a field both prior to, and substantially simultaneously with, the seed. In some cases, the biological product may be applied in furrow. The biological product may include modified or unmodified organisms. In some cases, the modified or unmodified organisms may

interact with the crop plants by associating with the crop plants, for example, by associating with the roots. In some cases, the biological product may be a bacterium, a fungus, an algae, an archaea, or a protozoan. In certain cases, the biological product may be a consortium of microorganisms. In various cases, the biological product may comprise a diazotroph or a phosphate-solubilizing microbe. In some cases, the biological product may comprise a genetically modified microbe.

In some embodiments, the system may combine or mix the biological product with a second solution including water, fertilizer, nutrients, herbicides, pesticides, fungicides, insecticides, or other components that are to be added to a field. The system may keep or maintain the biological product and the second solution separate until shortly before being disposed onto a seed and/or into a furrow in a field. The biological product may have a longer shelf life when the biological product is not in contact with the second solution. Furthermore, the tank for the biological product may be configured to maintain the viability of the biological product, for example, by maintaining the biological product within a predetermined temperature range and/or by preventing or inhibiting the biological product from coming into contact with direct sunlight.

Any methods provided herein include one or more actions or steps for performing the method. The method actions and/or steps may be interchanged with one another. Stated another way, unless a specific order of actions or steps is required for proper operation of an embodiment, the order and/or use of specific actions and/or steps may be modified. Moreover, sub-routines or only a portion of a method provided herein may be a separate method within the scope of this disclosure. In other words, some methods may include only a portion of the actions or steps described in a more detailed method.

The terms “connected to,” “coupled to,” and “in communication with,” as used herein, generally refer to any form of interaction between two or more entities, including mechanical, electrical, fluid, and thermal interaction. Two components may be coupled to each other even though they are not in direct contact with each other. For example, two components may be coupled to each other through an intermediate component.

As used herein with regard to an amount, the term “about” generally refers to values slightly outside the cited values, e.g., plus or minus from 0.1% to 10%.

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

### Systems for Delivery of Biological Products

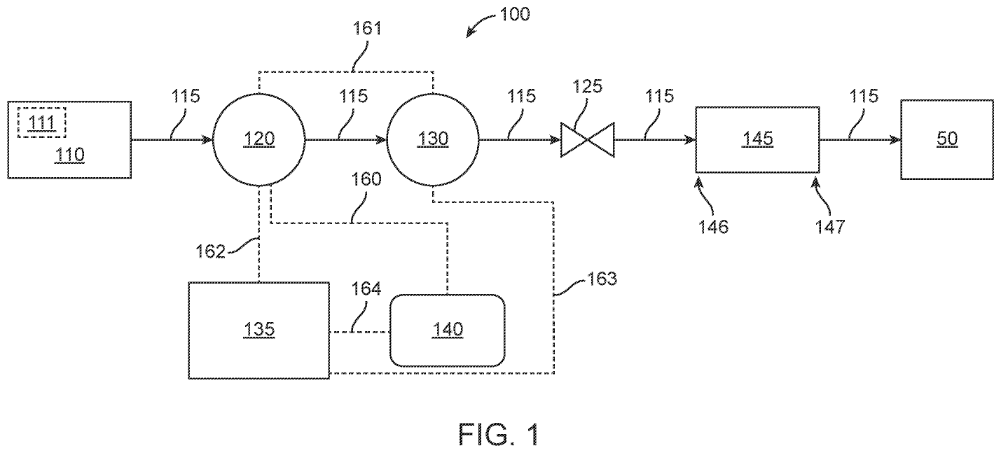

FIG. 1 illustrates an embodiment of an apparatus or system 100 for delivering a biological product. As shown in FIG. 1, the system 100 may include a first container or tank 110 (e.g., a biological container), a fluid flow path 115 in fluid communication with at least the first container 110, and at least one fluid flow unit 120 configured to subject a first solution 111 to flow from within the first container 110 along at least a portion of the first fluid flow path 115. Other configurations of these and other components of a system for delivering a biological product are also within the scope of this disclosure.

The first container 110 may contain, or be configured to contain, the first solution 111. The first container 110 may be formed from a polymer, a metal, or any other suitable material. In some instances, the first container 110 may be formed from a material that is compatible with the first solution 111 (e.g., the biological product). In other words, the material may be biocompatible. For example, the material may be biocompatible such that the first container 110, or the material(s) forming the first container 110, does not negatively, or substantially negatively, impact or interact with the first solution 111. In some embodiments, the first container 110 may be formed from a polyethylene (e.g., a high density polyethylene (HDPE) or a low density polyethylene (LDPE)), a polyethylene terephthalate (PET), a polypropylene (PP), a polystyrene (PS), a polyvinyl chloride (PVC), another suitable polymer, or any combination thereof. In certain embodiments, the first container 110 may be formed from aluminum, steel (e.g., stainless steel), copper, another suitable metal, or any combination thereof.

A volume of the first container 110 may be from 10 gallons to 100 gallons, 20 gallons to 60 gallons, 30 gallons to 50 gallons, 35 gallons to 45 gallons, or any other suitable volume. In certain embodiments, the first container 110 may consist essentially of the first solution 111, and the first solution 111 may consist essentially of the biological product. Accordingly, the first container 110 may hold only, or substantially only, the first solution 111. Stated another way, contents of the first container 110 may consist essentially of the first solution 111. As a result, the contents of the first container may be more stable than when present in a container which combines the biological product and other elements (e.g., fertilizer, nutrients, pesticides, herbicides, etc.). The first container may also be lighter than a container which contains the biological product in combination with other elements. As a result, use of the system may have fewer deleterious results on a field, e.g., due to less compaction of the ground as the biological product is applied to a field through the use of a lighter system than one in which the biological product and other elements are combined.

The first solution 111 may include a biological product. In certain embodiments, the biological product may include a biological, an agricultural biological, a microorganism (e.g., a bacterium, a fungus, an archaea, or any other suitable microbe), a genetically engineered microorganism, and/or a consortium of two or more microorganisms (e.g., plant beneficial microbes). In various cases, the biological product may include nitrogen-fixing microbes; phosphate-solubilizing microbes; microbes with insecticidal, pesticidal, and/or fungicidal properties; microbes which increase salinity, drought, and/or temperature tolerance; any other suitable microbes; or any combination thereof.

The first fluid flow path 115 may be coupled or couplable to a planting assembly 50 (e.g., a planter manifold). In some cases, the system 100 may deliver, or be configured to deliver, the first solution 111 to the planting assembly 50. Furthermore, the planting assembly 50 may deliver, or be configured to deliver, the first solution 111 to a field. For example, the planting assembly 50 may apply or dispose the first solution 111 in and/or on at least a portion of a field. In certain cases, at least a portion of the system 100 may be disposed, or be configured to be disposed, on the planting assembly 50. For example, the first container 110, the first fluid flow path 115, and the fluid flow unit 120 may be disposed on the planting assembly 50. In certain other cases, the system 100 may not be disposed on the planting assembly 50. For example, the system 100 may be disposed on a tractor or other suitable vehicle.

The fluid flow unit 120 may alter or vary a flow rate of the first solution 111 (e.g., through at least a portion of the first fluid flow path 115). For example, the fluid flow unit 120 may vary a flow rate of the first solution 111 based on a speed of the system 100 relative to a field. The rate of the fluid flow unit 120 may be increased as the speed of the system 100 increases. In contrast, the rate of the first fluid flow unit 120 may be decreased as the speed of the system 100 decreases. In some instances, the system 100 may further include a first flowmeter 130 that detects or measures the flow rate of the first solution 111 through at least a portion of the first fluid flow path 115. The first flowmeter 130 may include a sensor that is disposed within at least a portion of the first fluid flow path 115 (e.g., within a lumen of the first fluid flow path 115). The sensor may detect or measure the flow rate of the first solution through the first fluid flow path 115. Other configurations of the first flowmeter 130 are also within the scope of this disclosure.

In some embodiments, the at least one fluid flow unit 120 may be coupled and/or operably coupled to a speed reader 140. For example, the at least one fluid flow unit 120 may be operably coupled to the speed reader 140 via a communication system 160. Furthermore, the speed reader 140 may detect or measure the speed of the system 100 relative to the field. In some embodiments, the speed reader 140 may be a speedsource, a global positioning system (GPS), a radar, a wheel speed sensor or a simulated speed calculator. In some embodiments, the fluid flow unit 120 may be coupled and/or operably coupled to the first flowmeter 130. For example, the fluid flow unit 120 may be operably coupled to the first flowmeter 130 via a communication system 161. The fluid flow unit 120 may include or be a first pump. In various cases, a capacity of the first pump may be from 0.01 gallon per minute (GPM) to 10 GPM, 0.02 GPM to 9 GPM, 0.03 GPM to 8 GPM, 0.04 GPM to 7 GPM, or any other suitable capacity. In some cases, the capacity of the first pump may be from 0.05 GPM to 2.5 GPM. In certain embodiments, a rate of the first pump may be altered or varied, for example, based on the speed of the system 100 relative to the field.

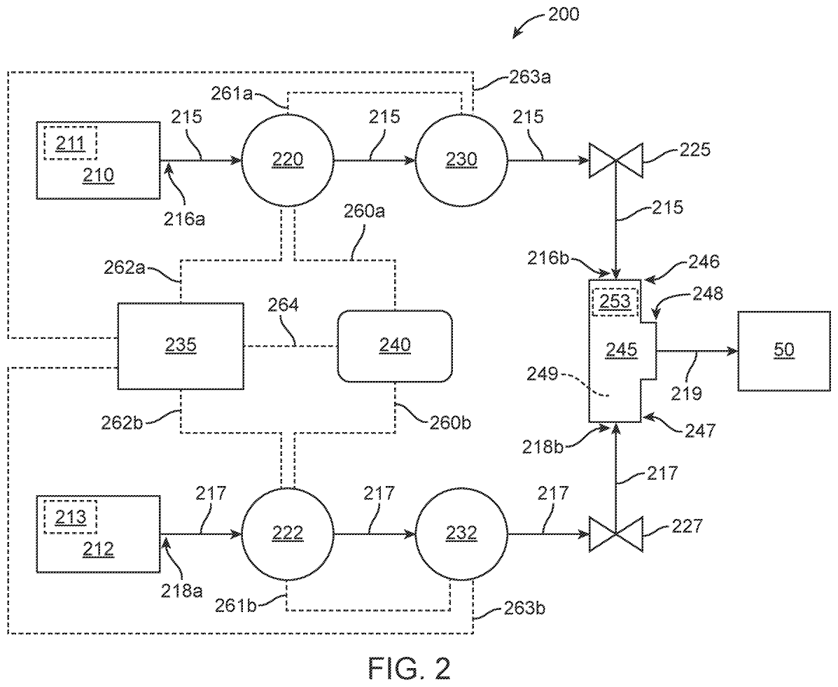

In some instances, the system 100 may also include a first valve 125. The first valve 125 may be disposed along at least a portion of the first fluid flow path 115. For example, the first valve 125 may be coupled to a portion of an adapter or intersection 145. In various cases, the system 100 may lack an adapter 145. In certain embodiments, the first valve 125 may be a one-way valve (e.g., a check valve). In certain other embodiments, the first valve may be a diaphragm valve, another suitable valve, or a combination thereof. The first valve 125 may allow or permit flow of the first solution 111 in a first direction (e.g., through at least a portion of the first fluid flow path 115). Furthermore, the first valve 125 may inhibit or limit flow of the first solution 111 in a second direction. The first direction may be opposite, or substantially opposite, of the second direction. In various embodiments, the first direction may be distal to or away from the first container 110 and the second direction may be proximal to or toward the first container 110. The first valve 125 may inhibit or limit contamination of the first container 110. For example, the first valve 125 may inhibit or limit passage of a second solution into a portion of the first fluid flow path 115 and/or the first container 110 from a position distal of the first valve 125 in relation to the first container 110. Such a configuration to inhibit or limit contamination of a first container by a second solution is described in further detail in reference to FIG. 2.

The system 100 may further include a controller 135. The controller 135 may include a computer including a processor operably coupled to a memory device. The memory device may store programming for accomplishing one or more functions of the controller. In some cases, the controller 135 may be operably coupled to the at least one fluid flow unit 120 (e.g., via a communication system 162), the first flowmeter 130 (e.g., via a communication system 163), and/or the speed reader 140 (e.g., via a communication system 164). Accordingly, the controller 135 can adjust a delivery rate of the first solution 111 to the field. The delivery rate of the first solution 111 may be from 0.01 gallon per acre (GPA) to 5 GPA, 0.05 GPA to 1 GPA, 0.1 GPA to 0.9 GPA, 0.2 GPA to 0.8 GPA, 0.3 GPA to 0.7 GPA, or any other suitable delivery rate.

FIG. 2 illustrates another embodiment of an apparatus or system 200 to deliver a biological product including a first container 210 (e.g., a biological container) and a second container 212. The embodiment of FIG. 2 may include components that resemble the components of the embodiment of FIG. 1 in some respects. For example, the embodiment of FIG. 2 includes the first container 210 that may resemble the first container 110 of FIG. 1. It will be appreciated that the illustrated embodiments may have analogous features. Accordingly, like features are designated with like reference numerals, with leading digits added to increment each reference numeral by 100. For instance, the first container is designated “110” in FIG. 1 and an analogous first container is designated as “210” in FIG. 2. Relevant disclosure set forth above regarding similarly identified features thus may not be repeated hereafter. Moreover, specific features of the system 200 and related components shown in FIG. 2 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the system 200 and related components of FIG. 2. Any suitable combination of the features, and variations of the same, described with respect to the system 100 illustrated in FIG. 1, can be employed with the system 200 and components of FIG. 2, and vice versa. This pattern of disclosure applies equally to further embodiments depicted in subsequent figures and/or described hereafter.

In the embodiment of FIG. 2, the system 200 includes the first container 210. The first container 210 may contain or hold a first solution 211, wherein the first solution 211 includes the biological product. The system 200 may further include the second container 212 (e.g., second tank). The second container 212 may contain or hold a second solution 213 as described in more detail below. In some embodiments, the system may include more than a first container and a second container. For example, the system may include three, four, five, or more containers. For example, the second solution may be disposed in a two separate containers and the two separate containers may be coupled to the intersection. The use of two or more separate first containers or second containers may assist in distribution of weight, for example, on the planting assembly.

As depicted, the system 200 may include a first fluid flow path 215, a second fluid flow path 217, and a third fluid flow path 219. The first fluid flow path 215 and the second fluid flow path 217 may meet at an adapter or intersection 245. The first fluid flow path 215 may be in communication or fluid communication with the first container 210. Moreover, the second fluid flow path 217 may be in communication or fluid communication with the second container 212. The system 200 may include at least one fluid flow unit (e.g., a first fluid flow unit 220) to subject the first solution 211 to flow from within the first container 210, along at least a portion of the first fluid flow path 215, and to the intersection 245. The system 200 may further include a second fluid flow unit 222 to subject the second solution 213 to flow from within the second container 212, along at least a portion of the second fluid flow path 217, and to the intersection 245.

Flow of the first solution 211 and the second solution 213 to the intersection 245 may yield a mixture 253 of the first solution 211 and the second solution 213 at the intersection 245. The intersection 245 may mix, or be configured to mix, the first solution 211 and the second solution 213 to form or generate the mixture 253. Furthermore, the mixture 253 may flow along at least a portion of the third fluid flow path 219. A fluid flow unit (e.g., the first fluid flow unit 220 and/or the second fluid flow unit 222) may subject the mixture 253 to flow along at least a portion of the third fluid flow path 219. In certain embodiments, a third fluid flow unit may subject the mixture 253 to flow along at least a portion of the third fluid flow path 219. For example, the third fluid flow unit may be coupled to the intersection 245 and/or the third fluid flow path 219.

In some embodiments, the system 200 may be configured such that flow of the first solution 211 and/or the second solution 213 may be driven or effectuated by a single fluid flow unit. In some other embodiments, the system 200 may include three fluid flow units, four fluid flow units, or another suitable number of fluid flow units.

The first container 210 may consist essentially of the first solution 211, and the first solution 211 may consist essentially of the biological product. Accordingly, the first container 210 may hold only, or substantially only, the first solution 211. Stated another way, contents of the first container 210 may consist essentially of the first solution 211. The biological product may include nitrogen-fixing microbes, phosphate-solubilizing microbes, or any combination thereof. The second container 212 may consist essentially of the second solution 213. In some embodiments, the second container 212 may hold only, or substantially only, the second solution 213. Stated another way, contents of the second container 210 may consist essentially of the second solution 211. The second solution 213 may include water, fertilizer, nutrients, herbicides, pesticides, fungicides, insecticides, or any combination thereof.

With continued reference to FIG. 2, the third fluid flow path 219 may be coupled or couplable to a planting assembly 50. The system 200 may deliver, or be configured to deliver, the mixture 253 to the planting assembly 50. As discussed above with reference to the system 100, at least a portion of the system 200 may be disposed, or be configured to be disposed, on the planting assembly 50. In various other cases, the system 200 may not be disposed on the planting assembly 50. For example, the system 200 may be disposed on a tractor or other suitable vehicle. The planting assembly 50 may apply, distribute, and/or dispose the mixture 253 in and/or on a field.

In certain embodiments, the system 200 may include a first valve 225. The first valve 225 may be disposed between the first container 210 and the intersection 245. For example, the first valve 225 may be coupled to the first container 210 (e.g., between the first container 210 and a first end 216a of the first fluid flow path 215), disposed along at least a portion of the first fluid flow path 215, or coupled to the intersection 245 (e.g., between a second end 216b of the first fluid flow path 215 and the intersection 245). In various embodiments, the first valve 225 may be a one-way valve (e.g., a check valve). In various other embodiments, the first valve 225 may be a diaphragm valve, another suitable valve, or a combination thereof.

The first valve 225 may allow or permit flow of the first solution 211 in a first direction and inhibit or limit flow of the first solution 211 in a second direction. In some instances, the first direction may be distal to or away from the first container 210 and the second direction may be proximal to or toward the first container 210 (e.g., through at least a portion of the first fluid flow path 215). In other words, the first direction may be opposite, or substantially opposite, of the second direction. The first valve 225 may also inhibit or limit contamination of the first container 210. For example, the first valve 225 may inhibit contamination of the first container 210 (e.g., by the second solution 213). The first valve 225 may inhibit or limit passage of the second solution 213 into at least a portion of the first fluid flow path 215 and/or the first container 210 from a position distal of the first valve 225 in relation to the first container 210. The shelf life, stability, and/or viability of the first solution 211 may be enhanced or improved when the first solution 211 is not combined or mixed with the second solution 213. Likewise, the shelf life, stability, and/or viability of the second solution 213 may be enhanced or improved when the second solution 213 is not combined or mixed with the first solution 211. For example, the shelf life, stability, and/or viability of the first solution 211 and/or the second solution 213 may be enhanced if the first solution 211 and the second solution 213 are not combined until less than 30 minutes, 20 minutes, 10 minutes, 5 minutes, 4 minutes, 3 minutes, 2 minutes, 1 minute, or 30 seconds prior to application of the first solution 211 and the second solution 213 to a field (e.g., as the mixture 253).

In certain cases, the first one-way valve 225 may be coupled or couplable to a first portion 246 of the intersection 245. As illustrated, the intersection 245 may be a T-shaped adapter including the first portion 246, a second portion 247 opposite of the first portion, and a third portion 248 disposed between the first portion 246 and the second portion 247. Furthermore, a lumen 249 may be disposed within at least a portion of the intersection 245. As such, each of the first portion 246, the second portion 247, and the third portion 248 may be in fluid communication with each other, e.g., via at least a portion of the lumen 249. The lumen 249 may be configured such that mixing of the first solution 211 and the second solution 213 may occur. In some other embodiments, the intersection may include only two portions (see, e.g., the intersection 145 of FIG. 1 including a first portion 146 and a second portion 147). In yet some other embodiments, the intersection may include four, five, six, or more portions. Other configurations of the intersection are also within the scope of the present disclosure.

In various instances, the system 200 may include a second valve 227. The second valve 227 may be disposed between the second container 212 and the intersection 245. The second valve 227 may be coupled to the second container 212 (e.g., at a position between the second container 212 and a first end 218a of the second fluid flow path 217), disposed along at least a portion of the second fluid flow path 217, or coupled to the intersection 245 (e.g., at a position between a second end 218b of the second fluid flow path 217 and the intersection 245). In various embodiments, the second valve 227 may be a one-way valve (e.g., a check valve). In various other embodiments, the first valve may be a diaphragm valve, another suitable valve, or a combination thereof.

The second valve 227 may allow or permit flow of the second solution 213 in a first direction and inhibit or limit flow of the second solution 214 in a second direction. In some instances, the first direction may be distal to or away from the second container 212 and the second direction may be proximal to or toward the second container 212. In other words, the first direction may be opposite, or substantially opposite, of the second direction. The second valve 227 may inhibit or limit contamination of the second container 212. For example, the second valve 227 may inhibit contamination of the first container 210 by the first solution 211. The second valve 227 may inhibit or limit passage of the first solution 211 into at least a portion of the first fluid flow path 215 and/or the second container 212 from a position distal of the second valve 227 in relation to the second container 212.

In some embodiments, the at least one fluid flow unit (e.g., the first fluid flow unit 220) may alter or vary a first flow rate of the first solution 211. The first fluid flow unit 220 may vary the first flow rate based on a speed of the system 200 relative to a field. The system 200 may include a first flowmeter 230 to detect or measure the first flow rate of the first solution 211 through at least a portion of the first fluid flow path 215. The first fluid flow unit 220 may be coupled and/or operably coupled to a speed reader 240. For example, the first fluid flow unit 220 may be operably coupled to the speed reader 240 via a communication system 260a. Moreover, the speed reader 240 may detect the speed of the system 200 relative to the field. In some embodiments, the speed reader 240 may be a speedsource, a GPS, a radar, a wheel speed sensor, or a simulated speed calculator. In some embodiments, the first fluid flow unit 220 may be coupled and/or operably coupled to the first flowmeter 230. For example, the first fluid flow unit 220 may be operably coupled to the first flowmeter 230 via a communication system 261a.

The first fluid flow unit 220 may include or be a first pump and the second fluid flow unit 222 may include or be a second pump. In some instances, a rate of the first pump may be altered or varied, for example, based at least in part on the speed of the system 200 relative to the field. The rate of the first pump and/or the second pump may be increased as the speed of the system 200 increases. In contrast, the rate of the first pump and/or the second pump may be decreased as the speed of the system decreases. The first flowmeter 230 may include a sensor that is disposed within at least a portion of the first fluid flow path 215 (e.g., within a lumen of the first fluid flow path 215). The sensor may detect or measure a flow rate of the first solution 211 through at least a portion of the first fluid flow path 215. As discussed above, other configurations of the flowmeters (e.g., the first flowmeter 230 and the second flowmeter 232) are also within the scope of this disclosure.

The first fluid flow unit 220 may include or be a first pump. In various cases, a capacity of the first pump may be from 0.01 GPM to 10 GPM, 0.02 GPM to 9 GPM, 0.03 GPM to 8 GPM, 0.04 GPM to 7 GPM, or any other suitable capacity. In some cases, the capacity of the first pump may be from 0.05 GPM to 2.5 GPM. In certain embodiments, a rate of the first pump may be altered or varied based at least in part on the speed of the system 200 relative to the field.

The at least one fluid flow unit may include a plurality of fluid flow units (e.g., a first fluid flow unit, a second fluid flow unit, a third fluid flow unit, or another suitable number of fluid flow units). The second fluid flow unit 222 may alter or vary a second flow rate of the second solution 213, for example, based at least in part on a speed of the system 200 relative to the field. Furthermore, a second flowmeter 232 may detect or measure the flow rate of the second solution 213 through at least a portion of the second fluid flow path 217. The second fluid flow unit 222 may be operably coupled (e.g., via a communication system 260b) to the speed reader 240. In certain cases, the speed reader 240 may detect or measure the speed of the system 200 relative to the field. In various embodiments, the second fluid flow unit 222 may be operably coupled (e.g., via a communication system 261b) to the second flowmeter 232.

The second fluid flow unit 222 may include or be a second pump. Moreover, a rate of the second pump may be altered or varied, for example, based at least in part on the speed of the system 200 relative to the field. In various cases, a capacity of the second pump may be from 1 GPM to 15 GPM, 1.5 GPM to 12 GPM, 2 GPM to 10 GPM, 4 GPM to 8 GPM, or any other suitable capacity. In some cases, the capacity of the second pump may be from 3 GPM to 7.5 GPM. In some other cases, the capacity of the second pump may be about 5.5 GPM. In certain embodiments, a rate of the second pump may be altered or varied, for example, based at least in part on the speed of the system 200 relative to the field.

The system 200 may further include a controller 235 operably coupled to the first pump (e.g., via a communication system 263a), the second pump (e.g., via a communication system 263b), the first flowmeter 220 (e.g., via a communication system 262a), the second flowmeter 222 (e.g., via a communication system 262b), and/or the speed reader 240 (e.g., via a communication system 264). The controller 235 may adjust a delivery rate of the mixture to the field. The delivery rate of the mixture may be from 1 GPA to 10 GPA, 1.5 GPA to 8 GPA, 2 GPA to 6 GPA, 3 GPA to 5 GPA, 3.5 GPA to 4.5 GPA, or any other suitable delivery rate. The controller 235 may also be configured to direct the first fluid flow unit 220 to regulate the first flow rate against a first setpoint flow rate (e.g., a predetermined flow rate). Moreover, the controller 235 may be configured to direct the second fluid flow unit 222 to regulate the second flow rate against the setpoint flow rate or a second setpoint flow rate. In some cases, the first setpoint flow rate may be less than the second setpoint flow rate, substantially equal to the second setpoint flow rate, or greater than the second setpoint flow rate.

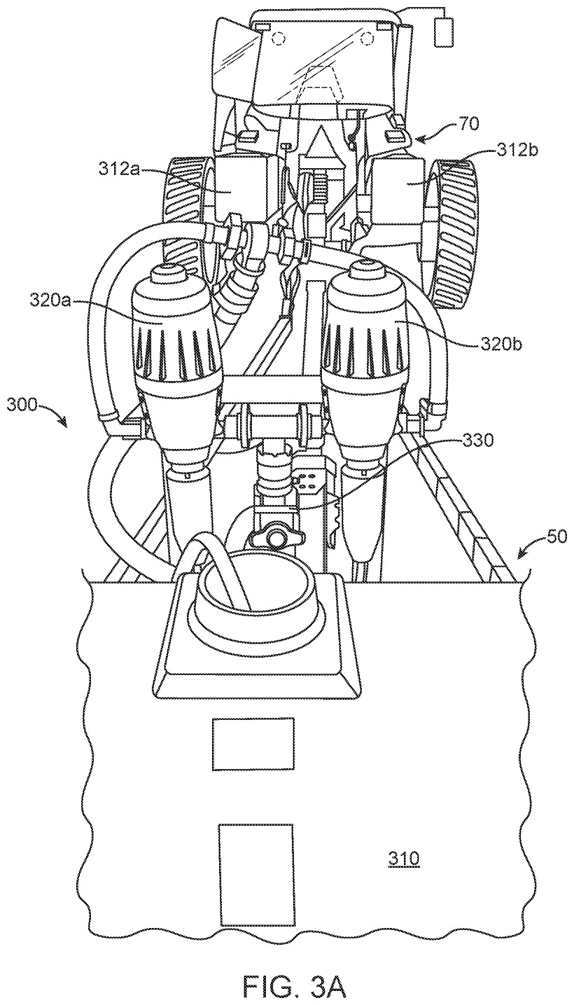

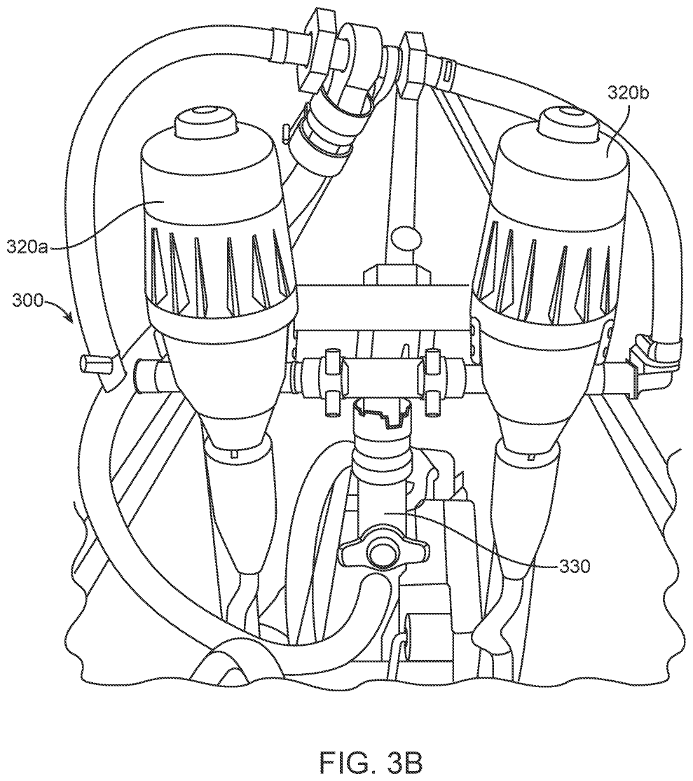

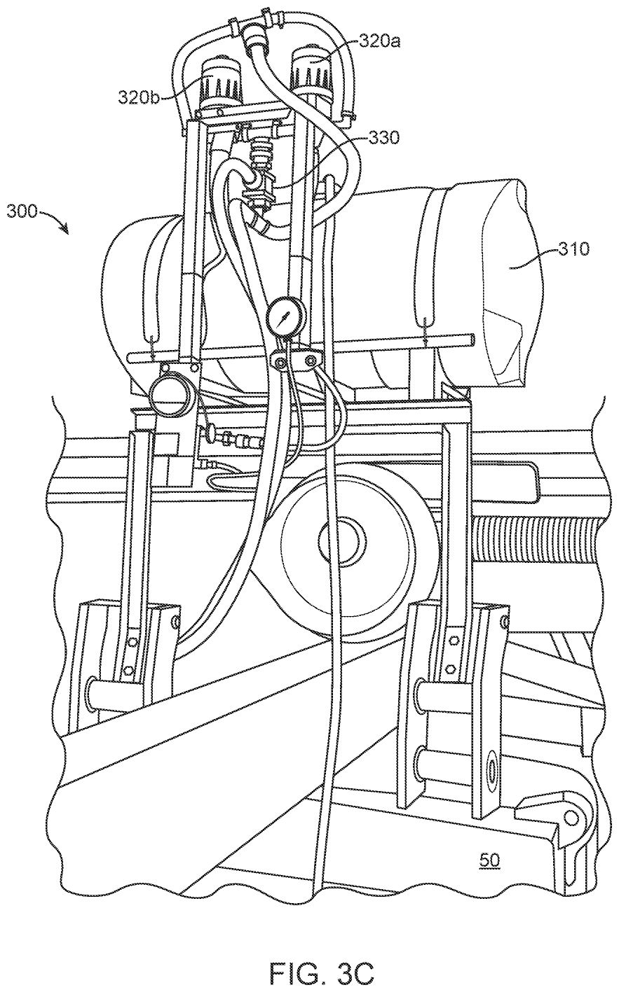

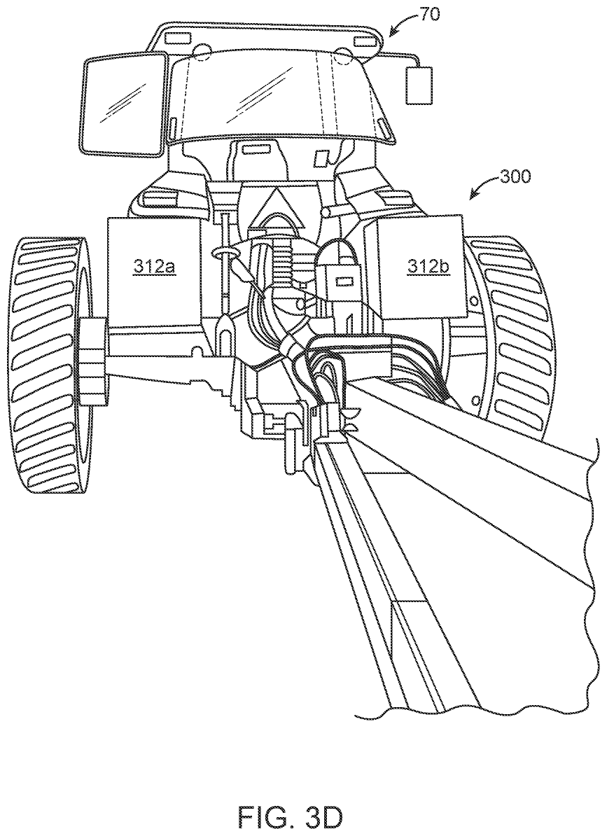

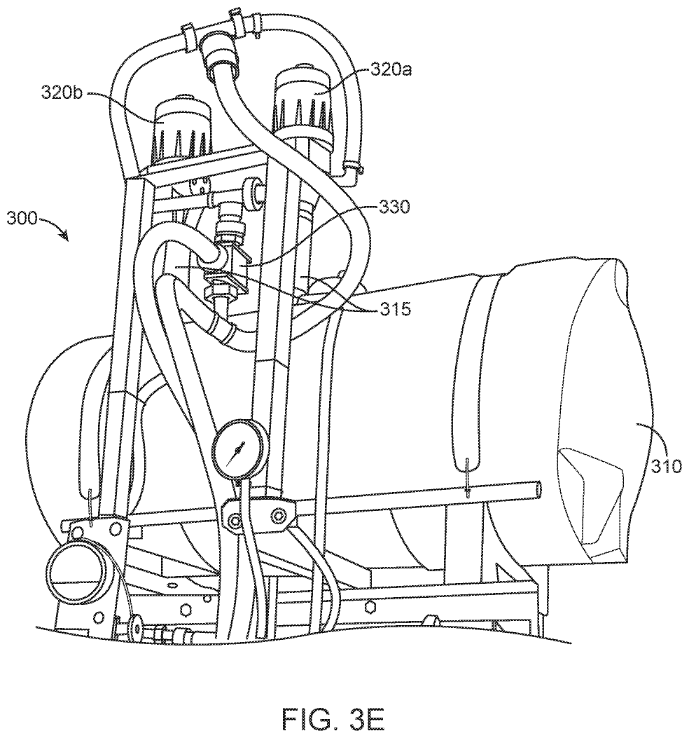

FIGS. 3A-3E depict various views of another embodiment of a system 300 for delivering a biological product. A portion of the system 300 can be coupled to a tractor 70 and another portion of the system 300 can be coupled to a planting assembly 50. The system 300 includes components and features that resemble, in some respects, the components and features of the system 100 of FIG. 1 and the system 200 of FIG. 2. Accordingly, like components and features are designated with like reference numerals, with a leading digit of “3” to increment each reference numeral. For instance, the first container is designated “110” in FIG. 1, an analogous first container is designated as “210” in FIG. 2, and an analogous first container is designated as “310” in FIGS. 3A-3E. At least the following specific components and features of the system 300 are depicted in FIGS. 3A-3E: a first container 310; second containers 312a, 312b; a first fluid flow path 315; first fluid flow units 320a, 320b; and a first flowmeter 330. The relevant descriptions of the components and features of the system 100 of FIG. 1 and the system 200 of FIG. 2 can apply to the features of the system 300 and related components of FIGS. 3A-3E. A fluid flow unit of a system may include more than one pump. As shown in FIGS. 3A-3C and 3D, the system 300 can include a pump 320a and a pump 320b. The pumps 320a, 320b can subject a first solution to flow from within the first container 310 along at least a portion of the first fluid flow path 315. A system may also include more than one second container. As shown in FIGS. 3A and 3D, the system 300 can include a second container 312a and a second container 312b. Each of the second containers 312a, 312b may be in fluid communication with each other. The second containers 312a, 312b may contain or hold a second solution.

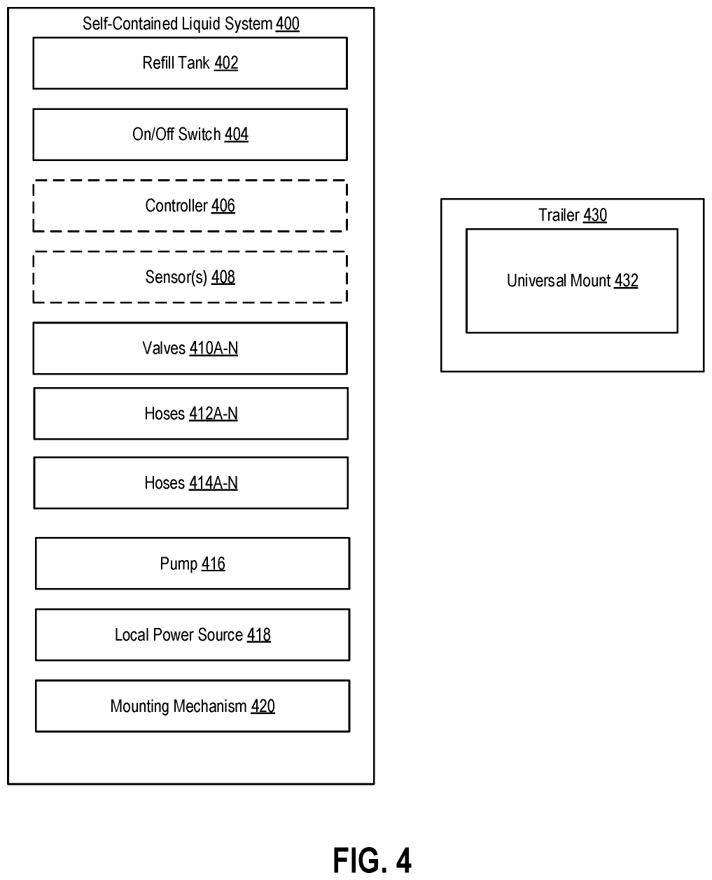

FIG. 4 is a block diagram of another embodiment of a system 400 for delivering a biological product. The system 400 can be a self-contained liquid system. The system 400 can be portable and small-scale. Therefore, the system 400 can be used by a user during furrow product trials. For example, a user may want to see results of a biological product on their farm or crops before investing in the product. Expensive and specialized equipment typically can be used to apply in furrow. However, since the disclosed system 400 is portable and small-scale, it can be more easily and economically used in trials of the biological product. The disclosed system 400 can also be advantageous because it can be deployed and used universally with any type of system, trailer, and/or tractor. The system 400 is self-contained because it can be deployed and actuated without being attached or hooked up to any power source and/or sensors of the trailer, tractor, or other planter assembly that the system 400 is coupled with. For example, the system 400 does not require being attached to a speed source of the trailer, tractor, or other planter assembly.

Referring to FIG. 4, the system 400 can include a refill tank 402, an on/off switch 404, a controller 406, sensor(s) 408, valves 410A-N, a first set of hoses 412A-N, a second set of hoses 414A-N, a pump 416, a local power source 418, and a mounting mechanism 420. In some examples, the system 400 may optionally include the controller 406 and/or the sensor(s) 408. Additionally, as depicted in FIG. 4, a trailer 430 can include a universal mount 432. The universal mount 432 can be part of the system 400. The universal mount 432 can be configured to mate with the mounting mechanism 420 such that the system 400 can be installed on the trailer 430. The universal mount 432 can be configured to any trailer 430 and can provide for a variety of mounting options. For example, the universal mount 432 can be mounted to any portion of a tractor, planting assembly, and/or the trailer 430. In some implementations, use of the universal mount 432 is optional and the system 400 can be attached to any part of the tractor, planting assembly, and/or trailer 430 without the universal mount 432. This functionality is beneficial for deploying the system 400 in different furrow trials.

The refill tank 402 can be filled with the biological product that the user is testing during furrow product trials. The tank 402 can be lightweight such that it can be easily picked up, installed, and deployed in the system 400 by the user. Additional people may not be required to prepare the refill tank 402 and configure the system 400. In some examples, the refill tank 402 can hold fifteen gallons of biological product. The tank 402 can be used for services three to five acres of land.

The on/off switch 404 can be attached to any of the components described herein in reference to the system 400. The switch 404 can be wireless, in which a fob or other type of wireless key can be used to turn the system 400 on and off. For example, the switch 404 can be used to power on and off the pump 416. In some implementations, a fob receiving or scanning surface can be attached to the refill tank 402. The user can then swipe or place the key fob over the scanning surface in order to actuate the system 400. The switch 404 can be positioned somewhere on the system 400 that is convenient for the user and does not require an actual mechanical key to operate the system 400. In other examples, the switch 404 can be an actual switch that the user flips up and/or down in order to actuate the system 400.

The controller 406 can be optionally included in the system 400. The controller 406 can be configured to receive one or more sensor readings to actuate one or more components of the system 400. For example, the controller 406 can determine a maximum desired pressure to release the biological product from the tank 402. The maximum desired pressure can be determined based on a sensed speed of a trailer, tractor, or other planter assembly that the system 400 is mounted or attached to.

Likewise, the system 400 can optionally include the sensor(s) 408. The sensor(s) 408 can be used to measure a speed at which the trailer, tractor, or other planter assembly that the system 400 is attached to is moving. The sensor(s) 408 is separate from sensors that may be attached to or be part of the trailer, tractor, or other planter assembly. This configuration is advantageous because the system 400 can be self-contained and easily deployed or installed to any trailer, tractor, or other planter assembly. The system 400 does not need to be attached or configured to communicate with one or more sensors or other components of the trailer, tractor, or other planter assembly. Therefore, the user can easily and quickly attach the system 400 and use the system 400 in furrow product trials.

In some examples, the sensor(s) 408 can be an accelerometer configured to measure a speed of the system 400 and/or the trailer, tractor, or other planter assembly that the system 400 is attached to. The sensor(s) 408 can also be a GPS sensor, which can be used to track and triangulate movement of the system 400. The sensor(s) 408 can be attached to the refill tank 402. The sensor(s) 408 can also be configured to any other components of the system 400 as described herein. The sensor(s) 408 can be in communication with the controller 406 such that the controller 406 can determine a desired pressure by which the biological product can be released from the refill tank 402 during furrow trials.

The self-contained liquid system 400 can also include the valves 410. The valves 410A-N can be controlled by the controller 406. The valves 410A-N can be opened and closed based on a number of rows that are being treated during the furrow trials. In some examples, the valves 410A-N can be relief valves. The controller 406 can set the maximum desired pressure, which can then be used to automatically adjust the valves 410A-N so that the biological product is released from the tank 402 in the desired amount.

The first set of hoses 412A-N (e.g., supply lines) can be pre-configured to the system 400. Therefore, the user does not have to set up the first set of hoses 412A-N before deployment of the system 400. The hoses 412A-N can run from the refill tank 402 to each of the valves 410A-N. The second set of hoses 414A-N (e.g., supply lines) can come with the system 400. The user can attach the hoses 414A-N to the valves 410A-N and run the hoses 414A-N to the rows of a planter assembly. In some implementations, the user may only attach a subset of the hoses 414A-N to a subset of the valves 410A-N. This can be possible where the system 400 has more valves 410A-N than rows of the planter assembly. In other examples, the user can choose to attach some of the hoses 414A-N to some of the valves 410A-N because the user wants to test the biological project on only some rows during the furrow trials.

The system 400 also includes the pump 416. The pump 416 can be controlled by the controller 406 and configured to release the biological product from the tank 402, through the first set of hoses 412A-N, through the valves 410A-N, and through the second set of hoses 414A-N at the desired pressure. The pump 416 can be electric. Moreover, the pump 416 can be actuated and/or turned on using the on/off switch 404 (e.g., a key fob). In some examples, the controller 406 and/or the sensor(s) 408 can be part of the pump 416.

The pump 416 can be powered by the local power source 418. Thus, the pump 416 does not need to be attached to a power source or any other components of the trailer or tractor that the system 400 is configured with. No cabling needs to be run to the system 400, which provides for a quick and simple deployment of the system on any trailer, tractor, or other planter assembly.

The local power source 418 can be a rechargeable battery. In other examples, the power source 418 can be one or more solar panels that can be charged while the system 400 is mounted to a trailer or tractor and is being used in the furrow trials. As another example, the power source 418 can be a generator that uses kinetic motion to supply power to one or more components of the system 400, such as the pump 416, the controller 406, and/or the sensor(s) 408. Moreover, in some examples, the power source 418 can include a wheel that descends from a portion of the system 400 and generates energy as the wheel moves across the ground at the speed by which the trailer, tractor, or other planter assembly is moving.

The system 400 further includes the mounting mechanism 420. The mounting mechanism 420 can be used to attach the system 400 to any tractor, trailer, or other planter assembly that can be used during furrow trials. In some implementations, the mounting mechanism 420 can include a first metal plate that mates to a second metal plate. The second metal plate can be the universal mount 432 that is configured to the trailer 430. Other mounting configurations are possible, as described herein.

The first metal plate (e.g., the mounting mechanism 420) can be configured to the refill tank 402 such that the refill tank 402 can be moved and installed onto different trailers or tractors. The valves 410A-N, pump 416, and/or local power source 418 can be configured to a portion of the mounting mechanism 420 such that the system 400 is easy to move and attach to different trailers, tractors, or planter assemblies. This configuration can make it easier and faster for the user to install the system 400 and deploy it with a trailer, tractor, or other planter assembly during furrow trials.

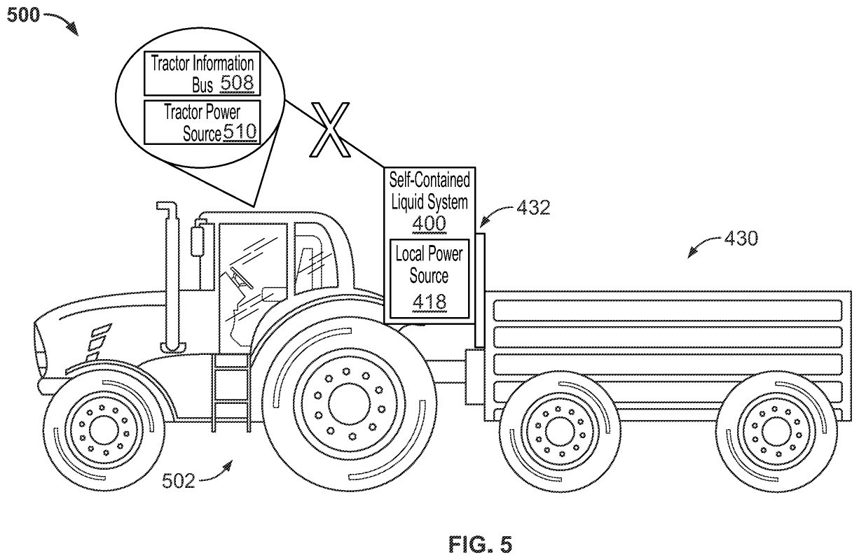

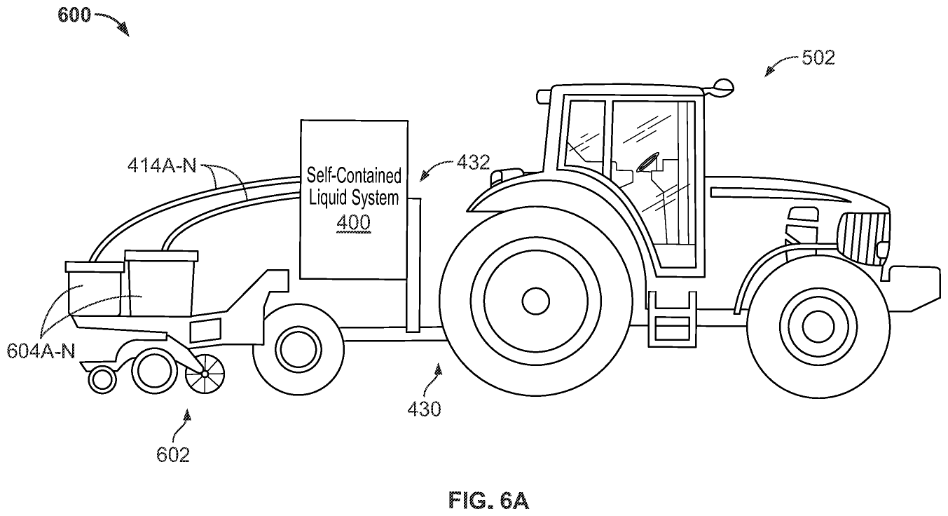

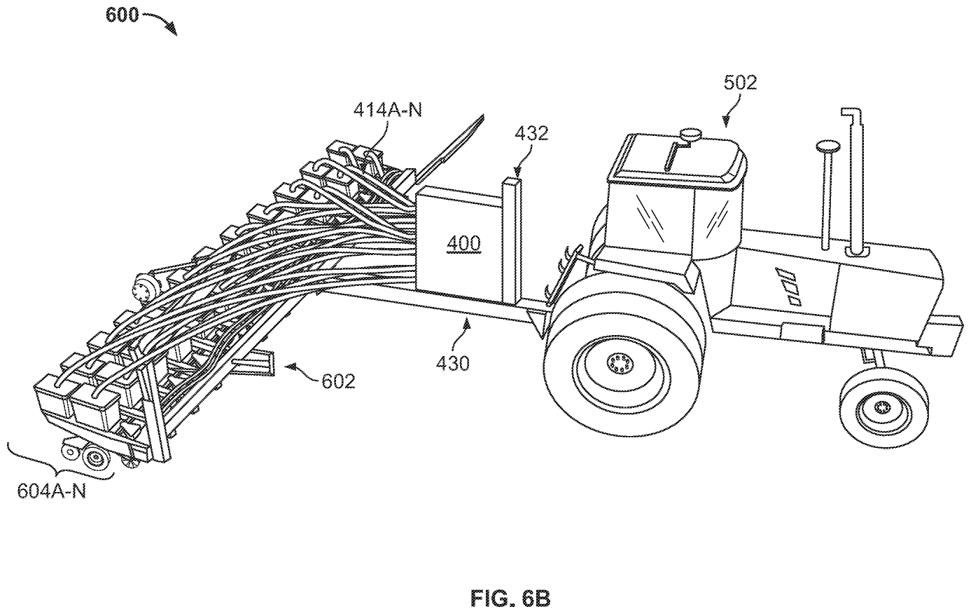

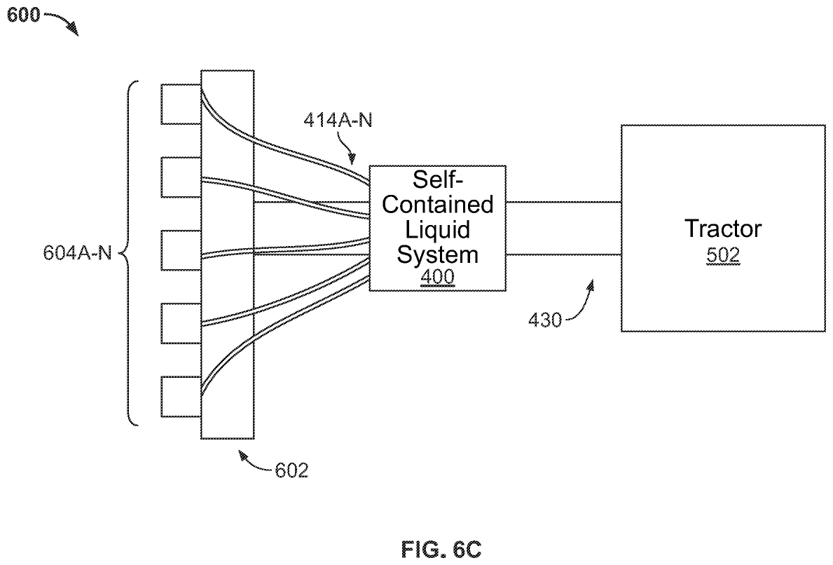

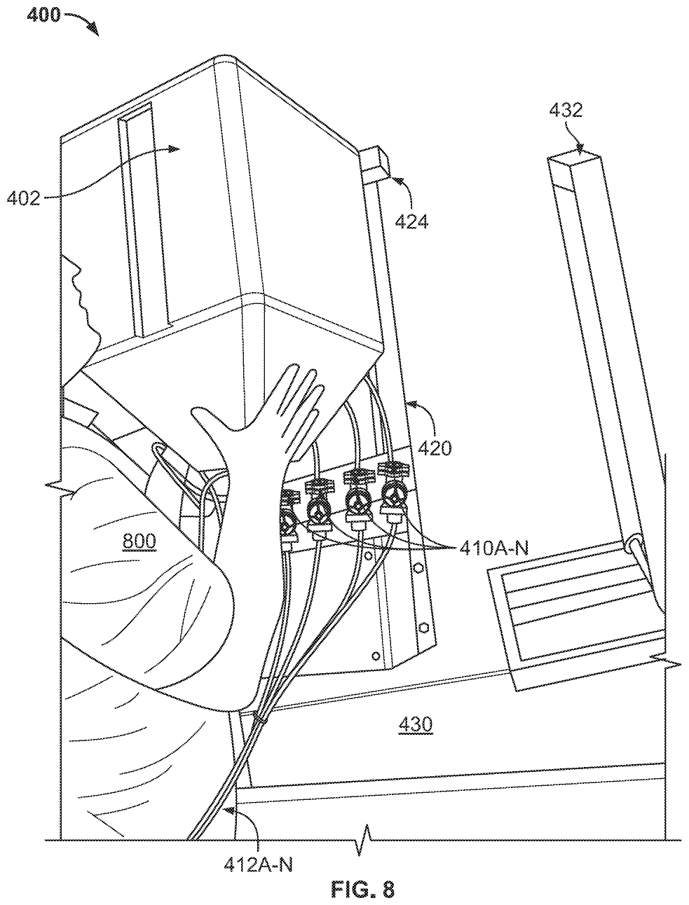

FIG. 5 is a side perspective view of a system 500 having the self-contained liquid system 400 of FIG. 4. As depicted, the system 500 can include a tractor 502, the trailer 430, and the self-contained liquid system 400. A planter assembly can be attached to the trailer 430 and/or the tractor 502 (e.g., refer to FIGS. 6A-C). The trailer 430 can be configured to the tractor 502 using known techniques. The universal mount 432 can also be attached to the trailer 430 such that the system 400 can be mounted thereon and deployed. As another example, the system 400's mounting mechanism 420 can include an overhang portion (e.g., refer to FIG. 8) that can latch over or hang on a handrail or other railing of the trailer 430. Therefore, the user would not have to install additional hardware, such as the universal mount 432, to the trailer 430 in order to deploy and use the system 400 in furrow trials

The tractor 502 can have a tractor information bus 508 and a tractor power source 510. The tractor information bus 508 can include sensors that are configured to measure a speed and/or GPS location of the tractor 502 as it moves through the fields. The bus 508 can also include any other relevant information for controlling, operating, and/or managing operations of the tractor 502. The tractor power source 510 can provide power to one or more components of the tractor 502, such as the tractor information bus 508. The tractor power source 510 can be a battery (e.g., rechargeable), solar panels, and/or other types of power supplies configured for tractors.

As depicted, the tractor information bus 508 and the tractor power source 510 are separate from the system 400. In other words, the system 400 is not in communication with or connected to any components of the tractor 502—the system 400 is self-contained. The system 400 has its own local power source 418, and therefore the system 400 does not need to be connected to the tractor power source 510 to operate. Moreover, the system 400 does not need to be connected to the tractor information bus 508 to operate because the system 400 can include sensor(s) 408 or other components to determine a desired flow rate of biological product. Thus, the system 400 can be easily and quickly installed and deployed in any system 500 configuration.

FIG. 6A is a side view of a system 600 of FIG. 5. The system 600 includes the tractor 502, the trailer 430, and a planter assembly 602. The trailer 430 can be configured to the tractor 502 using known techniques. The planter assembly 602 can also be configured to the trailer 430 using known techniques. The planter assembly 602 can have rows 604A-N. The rows 604A-N can be configured to service a plurality of rows in a field during furrowing and/or trials. As depicted in FIG. 6A, the universal mount 432 can be attached to a portion of the trailer 430. The self-contained liquid system 400 can then be mounted to the universal mount 432.

The second set of hoses 414A-N can run from the system 400 to each of the rows 604A-N. The user can choose to run only a subset of the hoses 414A-N to a subset of the rows 604A-N. For example, if the user wants to conduct furrow trials on three rows out of the rows 604A-N, the user can run three of the hoses 414A-N to three of the rows 604A-N. The second set of hoses 414A-N can come with the system 400, however the user can attach the hoses 414A-N before deployment of the system 400. Therefore, the user can customize their use of the system 400 to meet their particular needs. As described throughout, the user can attach a first end of each of the hoses 414A-N to each of the valves 410A-N. The user can then attach a second end of each of the hoses 414A-N to each of the rows 604A-N. This process can be performed easily and quickly by a single user.

FIG. 6B is a perspective view of the system 600 of FIG. 5. FIG. 6C is a top down view of the system 600 of FIG. 5. As depicted in both FIGS. 6B-6C, the hoses 414A-N are run from the self-contained liquid system 400 to each of the rows 604A-N of the planter assembly 602.

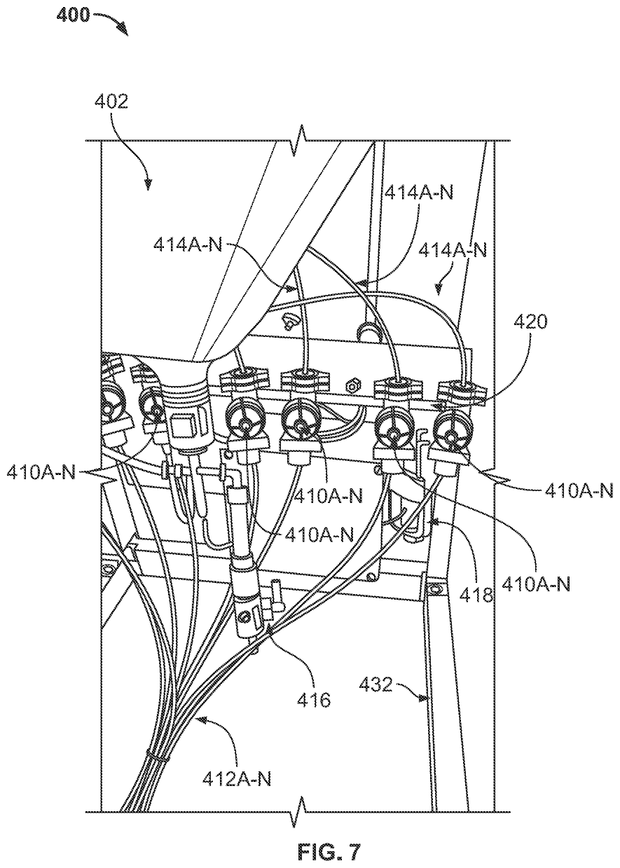

FIG. 7 is a rear perspective view of a portion of the system 400 of FIG. 4. The system 400 includes the mounting mechanism 420, which can be a metal plate that attaches to a universal mount 432 (e.g., trailer mount, base). The valves 410A-N can be attached or configured to the mounting mechanism 420, as depicted. The mounting mechanism 420 can be attached to the universal mount 432 using one or more fastening elements, such as screws. For example, the mounting mechanism 420 (e.g., a rail mount) can fit onto the universal mount 432 and can be kept from rattling by fastening one or more screws (e.g., thumb screws) lower on the mounting mechanism 420. In other implementations, as depicted in FIG. 8, the mounting mechanism 420 can include an overhang portion which can hang over any rail or handrail of the trailer 430, a tractor, and/or a planter assembly.

As described throughout, the system 400 can include the first set of hoses 412A-N pre-configured to the refill tank 402 and the valves 410A-N. Once the system 400 is mounted using the mounting mechanism 420, the refill tank 402 can be filled with a biological product. The second set of hoses 414A-N can be attached by the user to each of the valves 410A-N. In other words, the user can attach first ends of the hoses 414A-N to the valves 410A-N and then attach second ends of the hoses 414A-N to rows in a planter assembly.

Once the hoses 414A-N are attached to the system 400 and the system 400 is ready for deployment, biological product can flow from the tank 402, through the hoses 412A-N, into the valves 410A-N, and out through the hoses 414A-N. The pump 416 can be actuated and powered by the power source 418 in order to supply the biological product at a desired maximum pressure. Therefore, the pump 416 can moderate how much of the biological product flows through each of the valves 410A-N and out through the hoses 414A-N.

Since the system 400 operates using speed and pressure values, the system 400 does not need to be connected to a speed source or other component of the trailer or tractor. Moreover, as described herein, the valves 410A-N can be adjusted by a controller of the system 400 such that the biological product passes through the valves 410A-N at the desired rate and out through hoses 414A-N to be distributed to rows during furrow trials.

The controller can, for example, close any of the valves 410A-N that do not have hoses 414A-N attached thereon. One or more sensors can be located on the valves 410A-N to determine whether hoses 414A-N are attached. The controller can also adjust how much the valves 410A-N are opened such that the desired and/or calculated flow rate of the biological product can be achieved.

In other implementations (e.g., where the controller is not part of the system 400), the pump 416 can be used to achieve the desired flow rate of the biological product through the valves 410A-N. For example, the user can open any of the valves 410A-N that are connected to the hoses 414A-N. Once the valves 410A-N are manually opened and the pump 416 is actuated, the pump 416 can deliver the biological product through the opened valves 410A-N and out through the attached hoses 414A-N at the desired and/or calculate flow rate (e.g., pressure). In other examples, the pump 416 can be actuated at a speed by which the trailer, tractor, or planter assembly is moving. That speed can dictate the flow rate of the biological product through the opened valves 410A-N and out through the attached hoses 414A-N. In yet other examples, the pump 416 can be configured to deliver the biological product at a pre-defined flow rate (e.g., pressure). Based on that pre-defined flow rate, the user can be instructed to drive the tractor at a corresponding speed (e.g., the user cannot drive at whatever speed the user desires). Therefore, the user would have to drive the tractor at a certain speed to achieve the desired flow rate per acre of land during the furrow trials.

Configuring the system 400 for deployment can be a quick and easy process, taking approximately five to ten minutes.

FIG. 8 is a side perspective view of another portion of the system 400 of FIG. 4. The refill tank 402 can be attached or configured to the mounting mechanism 420. In the depicted example of FIG. 8, the mounting mechanism 420 is a metal plate having an overhang portion 424. A user 800 can lift the system 400 by the refill tank 402 and position the overhang portion 424 of the mounting mechanism 420 over a handrail or other railing structure of the trailer 430. In some examples, the overhang portion 424 can be hung over a horizontal bar, rail, or other structure of the universal mount 432, which is mounted or attached to the trailer 430. The user 800 can choose how to mount the system 400 based on their preferences, existing equipment, and/or other needs. The mounting configuration depicted herein is advantageous because it does not require the user 800 to fasten components together. For example, the user 800 does not have to screw the mounting mechanism 420 to the universal mount 432 or any other component of the trailer 430. Instead, the user 800 can merely hang the system 400 on the universal mount 432 and/or directly on the trailer 430. Thus, preparing and installing the system 400 for deployment can be a quick and easy process.

Moreover, the system 400 can be lightweight such that the user 800 can lift the system 400 and mount it to the trailer 430 without assistance from another person. In some implementations, the system 400 can weigh forty pounds before biological product is added to the refill tank 402. Since the system 400 is lightweight and easy to install, an installation process can take the user 800 approximately five to ten minutes.

Being that the system 400 is temporary and meant to be removed and deployed with different trailers, tractors, or other planter assemblies, the user 800 has to set up and take apart the system 400 with every use. However, the setting up and taking apart process can be simple, quick, and easy, which can involve as little as hanging the system 400 to a portion of the trailer 430 and attaching the hoses 414A-N to the valves 410A-N and rows of a planter assembly.

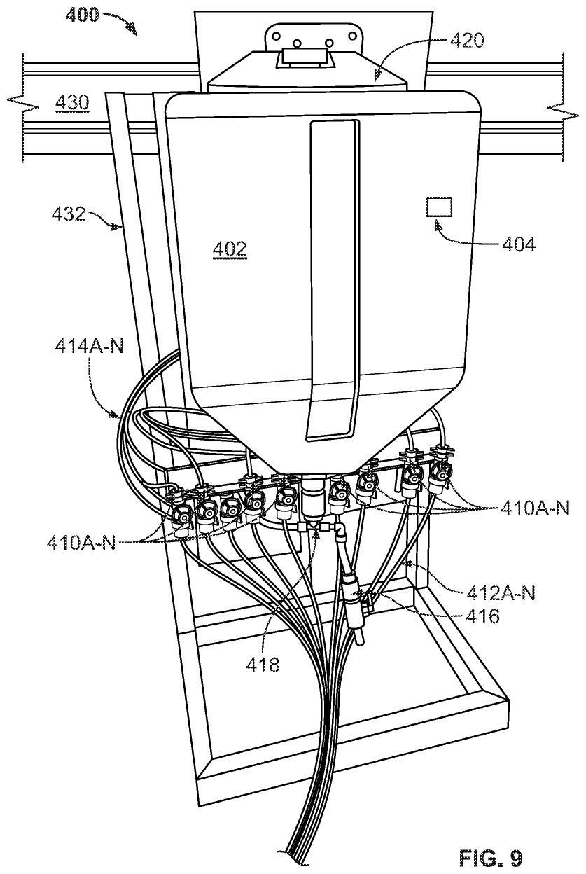

FIG. 9 is a rear perspective view of the system 400 of FIG. 4. The system 400 can be mounted via the mounting mechanism 420 to the universal mount 432. For example, the system 400 can be hung over a top rail of the universal mount 432 so that the user does not have to fasten (e.g., screw) the system 400 to any component of the trailer 430. The universal mount 432 is mounted to a back end of the trailer 430. The hoses 414A-N can be run from the valves 410A-N to rows of the trailer 430 or a planter assembly that is attached to the trailer 430.

When ready to begin furrow trials, the user can activate the pump 416 and the power supply 418 using the switch 404. For example, the user can swipe a key fob over the switch 404 (e.g., wireless activation). In other examples (not depicted), the user can flip the switch 404 up or down to activate or deactivate the power supply 418 and the pump 416 (e.g., wired activation). The switch 404 activation of the pump 416 and the local power supply 418 makes the system 400 self-contained. The system 400 does not need to be connected to any speed or power sources of the trailer 430, a tractor, the planter assembly, or any external speed or power sources. As a result, the system 400 can be quickly and easily deployed by the user for use in furrow trials.

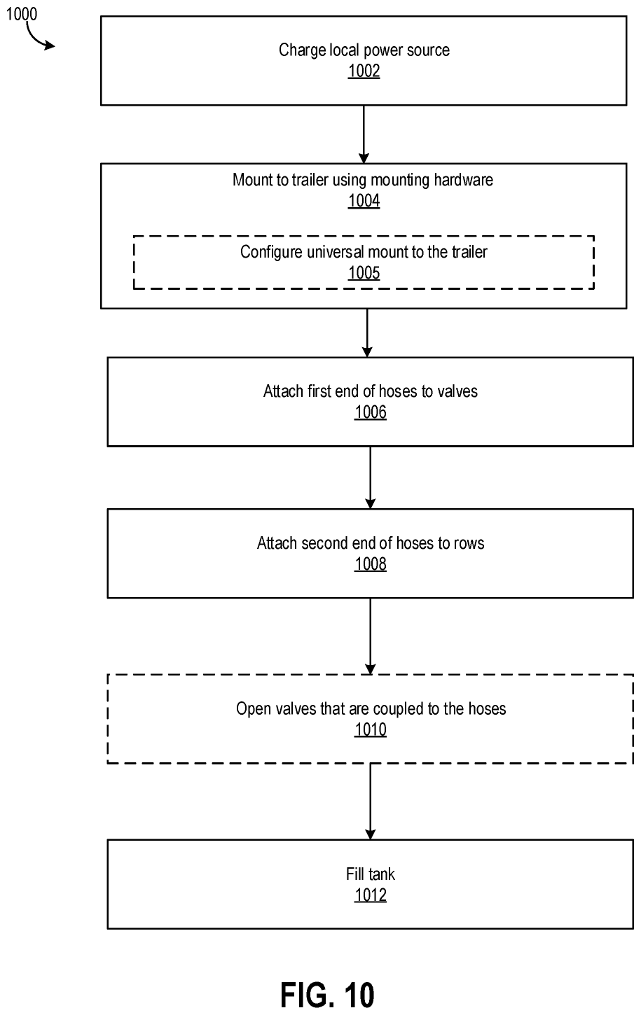

FIG. 10 is a flowchart of a process 1000 for installing and preparing the system of FIG. 4. The system can come pre-configured such that a user merely has to attach the system to a trailer, tractor, or planter assembly for deployment. In other words, components (e.g., refer to FIG. 4) such as a refill tank, valves, a first set of hoses, a controller, sensors, a pump, and a local power source can already be configured in the system and attached to a mounting mechanism.

The user can charge the local power source in 1002 (e.g., the local power source 418). The local power source can be a rechargeable battery. In some implementations, the power source can already be charged and the user does not have to charge it before a first use. As another example, if the local power source is a wheel that generates energy while the system attached to the trailer or tractor moves, then the power source does not have to be charged. In yet other examples, the local power source can be a replaceable battery. The system can come with additional (e.g., backup) power sources and/or the user can purchase additional power sources.

The user can mount the system to a trailer using mounting hardware in 1004 (e.g., the mounting mechanism 420 and the universal mount 432). The user can hang the system directly to a handrail or other rail structure of the trailer. The user can also attach the system directly to any portion of the trailer, tractor, or planter assembly using one or more fastening elements (e.g., screws, bolts).

The user can configure the universal mount described herein to the trailer in 1005. The universal mount can come with the system, thereby requiring the user to attach it to any desired location of the trailer, tractor, or planter assembly. The user can attach the universal mount to the trailer, as depicted and described herein. For example, the universal mount can be attached or mounted to the trailer or a planter assembly using ratchet straps. The user may also choose to attach the universal mount to the planter assembly such that hoses can be run more easily to rows of the planter assembly without getting tangled. The user may even choose to attach the universal mount to the tractor if, for example, the planter assembly is attached directly to the tractor rather than the trailer. The design of the universal mount is advantageous because it can be applied to any trailer, tractor, or planter assembly based on user preference and available equipment, thereby making deployment of the system easier, faster, and cost-efficient.

Once the universal mount is attached to the trailer, the user can hang the system on a rail of the universal mount, as described herein (1004). The user can also mate the mounting mechanism of the system to the universal mount using one or more fastening elements (e.g., screws, bolts). As described throughout the disclosure, the system as depicted in FIG. 4 can be lightweight. For example, the system can weigh forty pounds. Thus, the user can easily lift the system without assistance from another person and mount the system to the trailer.

The user can attach hoses (e.g., the hoses 414A-N) to each valve of the system in 1006 and 1008. The hoses can be used for supplying biological product from the system to rows in a field. Thus, the user can attach first ends of the hoses to the valves of the system in 1006. The user can attach second ends of the hoses to rows of a planter assembly in 1008. The hoses can come with the system. In some implementations, the first ends of the hoses can be pre-configured/attached to the system. The user would merely have to attach the send ends of the hoses to the rows of the planter assembly in 1008.

The user can run hoses to all of the valves of the system. However, in some implementations, the user may choose to run hoses to only some of the valves of the system. For example, the system can have more valves than there are rows in the field or rows of the planter assembly. As another example, the user may choose to use fewer valves because the user wants to treat fewer rows of the field with the biological product during furrow trials.

The user can attach the hoses to the system in a different order than that depicted in the process 1000. For example, the user can attach the first ends of the hoses to the valves (1006), mount the system to the trailer (1004), then attach the second ends of the hoses to the rows of the planter assembly (1008). The user can also attach the first and second ends of the hoses to the valves and the rows of the planter assembly, respectively (1006, 1008), and then mount the system to the trailer (1004). In yet other examples, the user can attach the second ends of the hoses to the rows of the planter assembly (1008), mount the system to the trailer (1004), then attach the first ends of the hoses to the valves of the system (1006). The system is easily and quickly configurable, which permits the user to install and prepare the system in any way that the user desires. Regardless of what order the user decides to install and prepare the system, the process 1000 can take a short amount of time (e.g., five to ten minutes) for fast deployment in furrow trials.

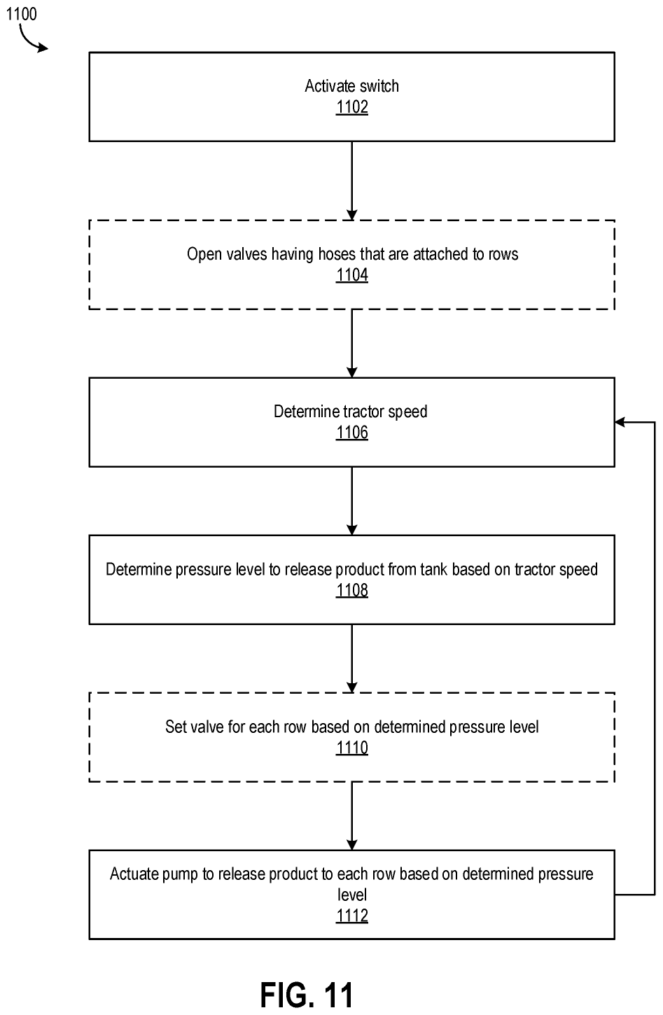

The user can optionally open the valves that are coupled to the hoses in 1010. The user can manually open the valves. In other examples, the valves can be automatically opened by a controller and/or pump that is part of the system (e.g., refer to the controller 406 and the pump 416 in FIG. 4; FIG. 11). In some implementations, valves are pre-configured to be open, which can speed up the process 1000 of installing and preparing the system for deployment. Therefore, the user merely closes any valves that are not coupled to hoses. In situations where all the valves are coupled to hoses, the user would not have to close any valves, thereby decreasing an amount of time that it takes the user to perform the process 1000.

The user can fill the tank with the biological product in 1012. The tank can be a fifteen gallon tank. The user can fill the tank with any amount of biological product up to and including fifteen gallons. In other examples, the tank can be a different size having a different capacity. The user can also fill the tank with the biological product before one or more other operations (1002-1010) in the process 1000. For example, the user can fill the tank before opening the valves that are coupled to the hoses 1010. As another example, the user can fill the tank before attaching the first ends of the hoses to the valves (1006) and/or attaching the second ends of the hoses to the rows of the planter assembly (1008).

The process 1000 can be quickly and easily performed by a single user to deploy the system for furrow trials (e.g., five to ten minutes to install and prepare the system). Any one or more operations (1002-1012) of the process 1000 can be performed in any order. Furthermore, once the furrow trials are completed, the user can disassembly the system based on the process 1000. For example, to disassemble, the user can close the valves that are coupled to the hoses, detach the hoses at the first ends and/or the second ends, and/or remove the system from the trailer (e.g., lifting the system off of the handrail or railing of the trailer or the universal mount). These operations can be performed in any order that the user desires. The user can also optionally charge the local power source so that it is ready for future use(s). The user does not have to disassemble components of the system itself. For example, the user does not have remove or detach the tank from the mounting mechanism, nor does the user have to detach hoses that run between the tank, the pump, and/or the valves. For these reasons, the system is configured to be easily installed, prepared, deployed for furrow trials, and also disassembled.

FIG. 11 is a flowchart of a process 1100 for using the system of FIG. 4. The process 1100 can be performed by a controller of the system (e.g., the controller 406). In some implementations, the controller can be combined with a pump (e.g., the pump 416) such that one or more operations of the process 1100 can be performed by the pump.

Once the user installs and prepares the system as described in reference to the process 1000 of FIG. 10, the user can activate a switch in 1102. The switch can be activated wirelessly. For example, the user can swipe a key fob to the switch. Activating the switch can also be performed mechanically, by flipping the switch up to turn on components of the system or flipping the switch down to turn off components of the system. Activating the switch can cause a local power source to actuate, thereby powering the pump, controller, and/or sensors (e.g., refer to FIG. 4).

In 1104, valves can be opened, wherein those valves are coupled to hoses that run to rows of a planter assembly. Opening the valves can be performed by the controller. For example, sensors can be attached to each of the valves. The sensors can detect that first ends of the hoses are coupled to the valves (e.g., refer to 1006 in FIG. 10) and communicate this detection to the controller. The controller can then automatically open the valves that are detected as coupled to the hoses. In other implementations, the valves are pre-configured to be open. Therefore, the controller can receive signals from the sensors that the valves are detected as not being coupled to the hoses. Based on these signals, the controller can automatically close the valves that are not coupled to the hoses. In yet other implementations (e.g., refer to the process 1000 in FIG. 10), the valves can be manually opened and/or closed by the user instead of the controller.

A tractor speed can be determined in 1106. To determine the tractor speed, a rate at which the product should be released from the system can be identified. In other words, the user can determine a desired or pre-defined pressure level/rate for the pump to provide the flow of the biological product. That determined rate can be correlated with a speed for the tractor. For example, a chart can be used that correlates tractor speed with pressure. By driving the tractor at the corresponding speed on the chart, the product can be released at the desired pressure. Therefore, if the tractor is being driven at a speed that is greater than the determined speed in 1106, the product will be released from the system at a slower rate. On the other hand, if the tractor is being driven at a speed less than the determined speed in 1106, then the product will be released at a faster rate. The system may not automatically adjust the product flow rate while the tractor is being driven at different speeds. Once determined, the tractor speed can be provided to the user so that the user knows to drive the tractor at the determined speed.

In other examples where the pump can provide differing flow rates or pressure levels, the tractor speed can be determined based on any flow rate and/or pressure level and/or a size of a field or a number of rows of the field that will receive the biological product.

Based on the determined tractor speed, the system can determine the pressure level by which to release the biological product from the tank in 1108. In other words, it can be determined what pressure level corresponds to the chosen or determined tractor speed. As mentioned above, a chart correlating speed with pressure can be used to determine the appropriate pressure level. In some implementations, an optimal pressure level can be determined and then a tractor speed that achieves the optimal pressure level can be determined. The pressure level to release the product from the tank to the valves can be different than a pressure level to release the product from the valves to the rows of the planter assembly. In other examples, the pressure level can be the same. In yet other examples, the pressure level can be determined only for releasing the product from the valves to the rows of the planter assembly.

The system can automatically set the valve for each row based on the determined pressure level in 1110. The controller can open or close each of the valves a certain amount that corresponds to the determined pressure level. In other words, the system can determine how much each of the valves should be opened such that a continuous flow of the biological product is evenly distributed to each of the rows during the furrow trials. In some implementations, automatically setting the valves based on the determined pressure level can be skipped.

The pump can be actuated to release the biological product through hoses that are coupled to each of the valves and rows based on the determined pressure value (1112). Actuating the pump can cause the biological product to move from the refill tank through one or more hoses to the valves. The product can then be pumped through the valves and through the hoses that connect to the rows of the planter assembly. The product can be pumped through the system at the determined pressure level and/or flow rate. Therefore, the pump can be configured to actuate based on the determined pressure level and/or flow rate. In other examples, the pump can be configured to actuate based on the determined tractor speed.

1006-1112 can be repeated for a duration of the furrow trials. 1006-1112 can optionally be repeated until the tank is empty or all of the biological product has been dispensed to the rows in the field. For example, one or more sensors on the tank can be used to detect an amount of product in the tank. When the sensors detect that no more product is in the tank, the controller can be configured to alert or notify the user. The user can then turn off the system using the switch. In other examples, the controller can be configured to automatically turn off the system. One or more sensors can also be configured to continuously detect a speed of the tractor. The sensed data can be transmitted to the controller. The controller can then determine whether the tractor is moving at the determined tractor speed that matches the determined flow rate and/or pressure level. If the controller determines that the tractor is moving at a different speed, the controller can alert or notify the user such that the user can accordingly adjust the speed by which the tractor is driven.

### Methods of Delivering Biological Products

Another aspect of the present disclosure is directed to methods for delivering a biological product. In various cases, the biological product may be applied or delivered to a field. The methods may include obtaining or providing a first fluid flow path. The first fluid flow path may be in fluid communication with a first container or tank. The container or tank may contain or hold a first solution comprising the biological product. In some embodiments, the methods may include adding the first solution to the first container. The methods may further include subjecting the first solution (e.g., the biological product) to flow from within the first container along at least a portion of the first fluid flow path.

In some embodiments, the methods may include coupling at least a portion of the first fluid flow path to a planting assembly. In some other embodiments, the methods may include coupling at least a portion of the first fluid flow path to a tractor or another suitable vehicle. The methods may further include applying the first solution to a field (e.g., via the planting assembly) at a rate of less than one GPA, one-half GPA, one-third GPA, one-fourth GPA, one-fifth GPA, one-sixth GPA, or any other suitable rate.

The methods may include activating at least one fluid flow unit (e.g., a pump). Activation of the at least one fluid flow unit may subject the first solution to flow from within the first container along at least a portion of the first fluid flow path. As discussed above, in certain embodiments, the at least one fluid flow unit may include or be a first pump.

In various cases, the methods may include adjusting or varying a rate of the first pump. The rate of the first pump may be adjusted or varied based at least in part on a speed of the system or the planting assembly relative to the field. For example, the rate of the first pump may be increased as the speed of the system increases. In contrast, the rate of the first pump may be decreased as the speed of the system decreases. In certain other embodiments, the methods may include adjusting or varying a rate of the first pump based on a width of the planting assembly. For example, a first planting assembly may have a first width and a second planting assembly may have a second width. The first width may be greater than the second width. As such, the rate may be higher when the first planting assembly is used in comparison to when the second planting assembly is used.

Methods for delivering a biological product may also include obtaining or providing a first fluid flow path, a second fluid flow path, and/or a third fluid flow path. In certain instances, the first fluid flow path and the second fluid flow path may meet at an adapter or intersection. In various instances, the first fluid flow path may be in fluid communication with a first container containing the first solution (e.g., the biological product). In various instances, the second fluid flow path may be in fluid communication with a second container or tank containing a second solution. As discussed above, the second solution may include water, fertilizer, nutrients, herbicides, pesticides, fungicides, insecticides, or any combination thereof. In various instances, the methods may include adding the second solution to the second container.

Methods for delivery of a biological product may include subjecting the first solution to flow from within the first container, along at least a portion of the first fluid flow path, and to the intersection. Furthermore, methods for delivery of a biological product may include subjecting the second solution to flow from within the second container, along at least a portion of the second fluid flow path, and to the intersection. Such flow of the first solution and the second solution may yield or result in a mixture of the first solution and the second solution at the intersection. For example, the first solution and the second solution may be combined or mixed at the intersection (e.g., the intersection may be configured to mix two or more solutions). In some embodiments, the mixture may flow along at least a portion of the third fluid flow path. The method may include subjecting the mixture to flow from within the intersection. The first solution may be mixed with the second solution, or vice versa, less than 30 minutes, 25 minutes, 20 minutes, 15 minutes, 10 minutes, 5 minutes, 3 minutes, 2 minutes, 1 minute, or 30 seconds prior to application of the mixture to the field.

In some cases, the methods of delivery of a biological product may further include activating the at least one fluid flow unit. For example, the at least one fluid flow unit (e.g., a pump) may be transitioned from an “off” state to an “on” state. In some other cases, the at least one fluid flow unit may be transitioned from an “on” state to an “off” state. In certain cases, activation of the at least one fluid flow unit may subject the first solution to flow from within the first container, along at least a portion of the first fluid flow path, and to the intersection. In various cases, activation of the at least one fluid flow unit may subject the second solution to flow from within the second container along at least a portion of the second fluid flow path to the intersection.

The at least one fluid flow unit may include a first pump and a second pump. In some embodiments, the at least one fluid flow unit may include a third pump, a fourth pump, a fifth pump, or any other suitable number of pumps.

In certain embodiments, the methods of delivery of a biological product may further include coupling or connecting the third fluid flow path to a planting assembly. As such, the mixture may be applied or administered to a field via the planting assembly. In various embodiments, the mixture may be applied to the field via the planting assembly at a rate of from 1 GPA to 10 GPA, 1.5 GPA to 8 GPA, 2 GPA to 6 GPA, 3 GPA to 5 GPA, 3.5 GPA to 4.5 GPA, or any other suitable rate of application. A user may monitor and/or adjust the rate of delivery of the biological product. For example, the user may be able to monitor and/or adjust the rate of delivery of the biological product from a cab of a tractor towing the planting assembly. In certain embodiments, the user may adjust one or more components (e.g., the fluid flow units, valves, etc.) of the system, for example, during use of the system.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system to deliver a biological product, comprising:
a first container configured to contain a first solution comprising the biological product;
a first fluid flow path, wherein the first fluid flow path is in fluid communication with the first container; and
at least one fluid flow unit configured to subject the first solution to flow from the first container along the first fluid flow path.

2. The system of claim 1, wherein the first fluid flow path is couplable to a planting assembly.

3. The system of claim 2, wherein the system is configured to deliver the first solution to the planting assembly.

4. The system of claim 2 or claim 3, wherein a portion of the system is configured to be disposed on the planting assembly.

5. The system of any one of claims 2-4, wherein the planting assembly is configured to dispose the first solution into a field.

6. The system of any one of claims 1-5, further comprising a first valve disposed along the first fluid flow path.

7. The system of claim 6, wherein the first valve is a one-way valve.

8. The system of claim 7, wherein the first valve is configured to allow flow of the first solution in a first direction and inhibit flow of the first solution in a second direction, wherein the first direction is distal to the first container, and wherein the second direction is proximal to the first container.

9. The system of any one of claims 6-8, wherein the first valve inhibits contamination of the first container.

10. The system of any one of claims 1-9, wherein the at least one fluid flow unit is configured to vary a flow rate of the first solution based on a speed of the system relative to a field.

11. The system of claim 10, further comprising a first flowmeter configured to detect the flow rate of the first solution through a portion of the first fluid flow path.

12. The system of claim 11, wherein the at least one fluid flow unit is operably coupled to a speed reader, and wherein the speed reader is configured to detect the speed of the system relative to the field.

13. The system of claim 11 or claim 12, wherein the at least one fluid flow unit is operably coupled to the first flowmeter.

14. The system of claim 13, wherein the at least one fluid flow unit is a first pump.

15. The system of claim 14, wherein a rate of the first pump is configured to be varied based on the speed of the system relative to the field.

16. The system of claim 14 or claim 15, wherein a capacity of the first pump is from 0.05 gallon per minute to 2.5 gallons per minute.

17. The system of any one of claims 12-16, further comprising a controller operably coupled to the at least one fluid flow unit, the first flowmeter, and the speed reader, wherein the controller is configured to adjust a delivery rate of the first solution to the field.

18. The system of claim 17, wherein the delivery rate of the first solution is from 0.05 gallon per acre to 1 gallon per acre.

19. The system of any one of claims 1-18, wherein a volume of the first container is from 20 gallons to 60 gallons.

20. The system of claim 19, wherein the volume of the first container is from 30 gallons to 50 gallons.

21. The system of any one of claims 1-20, wherein the first container consists essentially of the first solution and the first solution consists essentially of the biological product.

22. The system of any one of claims 1-21, wherein the biological product is selected from the group consisting of nitrogen-fixing microbes, phosphate-solubilizing microbes, and any combination thereof.

23. A system to deliver a biological product, comprising:
a first container configured to contain a first solution comprising the biological product;
a second container configured to contain a second solution;
a first fluid flow path, a second fluid flow path, and a third fluid flow path, wherein the first fluid flow path and the second fluid flow path meet at an intersection, and wherein the first fluid flow path is in fluid communication with the first container and the second fluid flow path is in fluid communication with the second container; and
at least one fluid flow unit configured to subject (i) the first solution to flow from the first container along the first fluid flow path to the intersection and (ii) the second solution to flow from the second container along the second fluid flow path to the intersection, to yield a mixture of the first solution and the second solution at the intersection, which mixture flows along the third fluid flow path.

24. The system of claim 23, wherein the third fluid flow path is couplable to a planting assembly.

25. The system of claim 24, wherein the system is configured to deliver the mixture to the planting assembly.

26. The system of claim 24 or claim 25, wherein a portion of the system is configured to be disposed on the planting assembly.

27. The system of any one of claims 24-26, wherein the planting assembly is configured to dispose the mixture into a field.

28. The system of any one of claims 23-27, further comprising a first valve disposed between the first container and the intersection.

29. The system of claim 28, wherein the first valve is a one-way valve.

30. The system of claim 29, wherein the first valve is configured to allow flow of the first solution in a first direction and inhibit flow of the first solution in a second direction, wherein the first direction is distal to the first container, and wherein the second direction is proximal to the first container.

31. The system of any one of claims 28-30, wherein the first valve inhibits contamination of the first container by the second solution.

32. The system of any one of claims 23-31, further comprising a second valve disposed between the second container and the intersection.

33. The system of claim 32, wherein the second valve is a one-way valve.

34. The system of claim 33, wherein the second valve is configured to allow flow of the second solution in a first direction and inhibit flow of the second solution in a second direction, wherein the first direction is distal to the second container, and wherein the second direction is proximal to the second container.

35. The system of any one of claims 32-34, wherein the second valve inhibits contamination of the second container by the first solution.

36. The system of claim 23, wherein the at least one fluid flow unit is configured to vary a first flow rate of the first solution based on a speed of the system relative to a field.

37. The system of claim 36, further comprising a first flowmeter configured to detect the first flow rate of the first solution through a portion of the first fluid flow path.

38. The system of claim 36 or 37, wherein the at least one fluid flow unit is operably coupled to a speed reader, and wherein the speed reader is configured to detect the speed of the system relative to the field.

39. The system of claim 37 or claim 38, wherein the at least one fluid flow unit is a first fluid flow unit operably coupled to the first flowmeter.

40. The system of claim 39, wherein the first fluid flow unit is a first pump.

41. The system of claim 40, wherein a rate of the first pump is configured to be varied based on the speed of the system relative to the field.

42. The system of claim 40 or claim 41, wherein a capacity of the first pump is from 0.05 gallons per minute to 2.5 gallons per minute.

43. The system of any one of claims 36-42, wherein the at least one fluid flow unit comprises a plurality of fluid flow units, and wherein a second fluid flow unit is configured to vary a second flow rate of the second solution based on a speed of the system relative to the field.

44. The system of claim 43, further comprising a second flowmeter configured to detect the flow rate of the second solution through a portion of the second fluid flow path.

45. The system of claim 43 or 44, wherein the second fluid flow unit is operably coupled to a speed reader, and wherein the speed reader is configured to detect the speed of the system relative to the field.

46. The system of claim 44 or claim 45, wherein the second fluid flow unit is operably coupled to the second flowmeter.

47. The system of claim 46, wherein the second fluid flow unit is a second pump.

48. The system of claim 47, wherein a rate of the second pump is configured to be varied based on the speed of the system relative to the field.

49. The system of claim 47 or claim 48, wherein a capacity of the second pump is from 3 gallons per minute to 7.5 gallons per minute.

50. The system of any one of claims 45-49, further comprising a controller operably coupled to the first pump, the second pump, the first flowmeter, the second flowmeter, and the speed reader, wherein the controller is configured to adjust a delivery rate of the mixture to the field.

51. The system of claim 50, wherein the delivery rate of the mixture is from 3 gallons per acre to 5 gallons per acre.

52. The system of any one of claims 23-51, wherein the first container consists essentially of the first solution and the first solution consists essentially of the biological product.

53. The system of any one of claims 23-52, wherein the biological product is selected from the group consisting of nitrogen-fixing microbes, phosphate-solubilizing microbes, and any combination thereof.

54. A method for delivering a biological product, comprising:
(a) providing a first fluid flow path, wherein the first fluid flow path is in fluid communication with a first container containing a first solution comprising the biological product; and
(b) subjecting the first solution to flow from the first container along the first fluid flow path.

55. The method of claim 54, further comprising coupling the first fluid flow path to a planting assembly.

56. The method of claim 55, further comprising applying the first solution to a field via the planting assembly at a rate of less than one-fifth gallon per acre.

57. The method of any one of claims 54-56, further comprising activating at least one fluid flow unit to subject the first solution to flow from the first container along the first fluid flow path.

58. The method of claim 57, wherein the at least one fluid flow unit is a first pump.

59. The method of claim 58, further comprising adjusting a rate of the first pump based on a speed of the planting assembly relative to the field.

60. The method of claim 59, wherein the rate of the first pump is increased as the speed of the planting assembly increases and wherein the rate of the first pump is decreased as the speed of the planting assembly decreases.

61. The method of any one of claims 58-60, further comprising adjusting a rate of the first pump based on a width of the planting assembly.

62. The method of any one of claims 54-61, wherein the biological product is selected from the group consisting of nitrogen-fixing microbes, phosphate-solubilizing microbes, or a combination thereof.

63. A method for delivering a biological product, comprising:
(a) providing a first fluid flow path, a second fluid flow path, and a third fluid flow path, wherein the first fluid flow path and the second fluid flow path meet at an intersection, and wherein the first fluid flow path is in fluid communication with a first container containing a first solution comprising the biological product and the second fluid flow path is in fluid communication with a second container containing a second solution; and
(b) subjecting (i) the first solution to flow from the first container along the first fluid flow path to the intersection and (ii) the second solution to flow from the second container along the second fluid flow path to the intersection, to yield a mixture of the first solution and the second solution at the intersection, which mixture flows along the third fluid flow path.

64. The method of claim 63, further comprising coupling the third fluid flow path to a planting assembly.

65. The method of claim 64, further comprising applying the mixture to a field via the planting assembly at a rate of from three to five gallons per acre.

66. The method of claim 65, wherein the first solution is mixed with the second solution less than 5 minutes prior to application of the mixture to the field.

67. The method of any one of claims 63-66, further comprising activating at least one fluid flow unit to subject (i) the first solution to flow from the first container along the first fluid flow path to the intersection and (ii) the second solution to flow from the second container along the second fluid flow path to the intersection.

68. The method of claim 67, wherein the at least one fluid flow unit comprises a first pump and a second pump.

69. The method of claim 68, further comprising adjusting a rate of the at least one fluid flow unit based on a speed of the planting assembly relative to the field.

70. The method of claim 69, wherein the rate of the at least one fluid flow unit is increased as the speed of the planting assembly increases and wherein the rate of the at least one fluid flow unit is decreased as the speed of the planting assembly decreases.

71. The method of any one of claims 68-70, further comprising adjusting a rate of the at least one fluid flow unit based on a width of the planting assembly.

72. The method of any one of claims 63-71, wherein the biological product is selected from the group consisting of nitrogen-fixing microbes, phosphate-solubilizing microbes, or a combination thereof.

73. The method of any one of claims 63-72, wherein the second solution comprises water, fertilizer, nutrients, or a combination thereof.

74. An apparatus, comprising:
a biological container configured to retain a biological product;
an adapter configured to couple the biological container to a planting assembly;
a first fluid flow unit configured to subject contents from within the biological container to flow toward the adapter;
a first flowmeter configured to detect a first flow rate of the contents from within the biological container;
a first one-way valve couplable to a first portion of the adapter; and
a controller operatively coupled to the first fluid flow unit and the first flowmeter, wherein the controller is configured to (i) measure the first flow rate of the contents from within the biological container and (ii) direct the first fluid flow unit to regulate the first flow rate against a setpoint flow rate.

75. The apparatus of claim 74, wherein a portion of the apparatus is configured to be disposed on the planting assembly.

76. The apparatus of claim 74 or claim 75, wherein the planting assembly is configured to dispose the contents from within the biological container into a field.

77. The apparatus of any one of claims 74-76, wherein the first one-way valve is configured to allow flow of the contents from within the biological container in a first direction and inhibit flow of the contents from within the biological container in a second direction, wherein the first direction is distal to the biological container, and wherein the second direction is proximal to the biological container.

78. The apparatus of any one of claims 74-77, wherein the first one-way valve inhibits contamination of the biological container.

79. The apparatus of any one of claims 74-78, wherein the first fluid flow unit is configured to vary the first flow rate based on a speed of the apparatus relative to a field.

80. The apparatus of claim 79, wherein the first fluid flow unit is operably coupled to a speed reader, and wherein the speed reader is configured to detect the speed of the apparatus relative to the field.

81. The apparatus of any one of claims 74-80, wherein the first fluid flow unit is operably coupled to the first flowmeter.

82. The apparatus of claim 81, wherein the first fluid flow unit is a first pump.

83. The apparatus of claim 82, wherein a rate of the first pump is configured to be varied based on the speed of the apparatus relative to the field.

84. The apparatus of claim 82 or claim 83, wherein a capacity of the first pump is from 0.05 gallons per minute to 2.5 gallons per minute.

85. The apparatus of any one of claims 74-84, further comprising:
a second container:
a second fluid flow unit configured to subject contents from within the second container to flow toward the adapter;
a second flowmeter configured to detect a second flow rate of the contents from within the second container; and
a second one-way valve couplable to a second portion of the adapter;
wherein the controller is further operatively coupled to the second flowmeter and the second fluid flow unit, wherein the controller is further configured to (iii) measure the second flow rate of the contents from within the second container and (iv) direct the second fluid flow unit to regulate the second flow rate against a setpoint flow rate.

86. The apparatus of claim 85, wherein the contents from within the biological container and the contents from within the second container yield a mixture at the adapter, which mixture flows along a third fluid flow path.

87. The apparatus of claim 86, wherein the planting assembly is configured to dispose the mixture into the field.

88. The apparatus of any one of claims 85-87, wherein the first one-way valve inhibits contamination of the biological container by the contents from within the second container.

89. The apparatus of any one of claims 85-88, wherein the second one-way valve is configured to allow flow of the contents from within the second container in a first direction and inhibit flow of the contents from within the second container in a second direction, wherein the first direction is distal to the second container, and wherein the second direction is proximal to the second container.

90. The apparatus of any one of claims 85-89, wherein the second one-way valve inhibits contamination of the second container by the contents from within the biological container.

91. The apparatus of claim 85, wherein the second fluid flow unit is configured to vary a second flow rate of the contents from within the second container based on the speed of the apparatus relative to the field.

92. The apparatus of claim 91, wherein the second fluid flow unit is operably coupled to the speed reader.

93. The apparatus of claim 91 or claim 92, wherein the second fluid flow unit is operably coupled to the second flowmeter.

94. The apparatus of claim 93, wherein the second fluid flow unit is a second pump.

95. The apparatus of claim 94, wherein a rate of the second pump is configured to be varied based on the speed of the apparatus relative to the field.

96. The apparatus of claim 94 or claim 95, wherein a capacity of the second pump is from 3 gallons per minute to 10 gallons per minute.

97. The apparatus of any one of claims 74-96, wherein the biological container consists essentially of the biological product.

98. The apparatus of any one of claims 74-97, wherein the biological product is selected from the group consisting of nitrogen-fixing microbes, phosphate-solubilizing microbes, and any combination thereof.

99. A fluid dispensing apparatus for farming, the apparatus comprising:
a biological container configured to retain a biological product;
a mounting mechanism configured to couple the biological container to a planting assembly;
a pump configured to subject contents from within the biological container to flow toward the mounting mechanism;
a plurality of one-way valves couplable to a first portion of the mounting mechanism;
a plurality of first hoses connecting the biological container to a first side of the plurality of one-way valves;
a plurality of second hoses configured to connect a second side of the plurality of one-way valves to supply lines of the planting assembly, wherein the contents from within the biological container flow, based on actuation of the pump, through (i) the plurality of first hoses, (ii) the plurality of one-way valves, and (iii) the plurality of second hoses to the supply lines of the planting assembly;
a local power source couplable to a second portion of the mounting mechanism and configured to power at least the pump; and
a switch couplable to the biological container and configured to, when actuated, activate the local power source.

100. The apparatus of claim 99, further comprising:
a controller couplable to a third portion of the mounting mechanism, wherein the controller is configured to:
determine a speed at which to move the planting assembly in a field;
determine, based on the speed, a pressure level to release the contents from within the biological container;
actuate, based on the pressure level, the pump to subject the contents from within the biological container to flow through (i) the plurality of first hoses, (ii) the plurality of one-way valves, and (iii) the plurality of second hoses to the supply lines of the planting assembly.

101. The apparatus of any one of claims 99-100, wherein a subset of the plurality of one-way valves can be opened to correspond to a quantity of the supply lines of the planting assembly.

102. The apparatus of any one of claims 99-101, wherein a portion of the apparatus is configured to be disposed on the planting assembly.

103. The apparatus of any one of claims 99-102, wherein the planting assembly is configured to dispose the contents from within the biological container into a field.

104. The apparatus of any one of claims 99-103, wherein the plurality of one-way valves is configured to allow flow of the contents from within the biological container in a first direction and inhibit flow of the contents from within the biological container in a second direction, wherein the first direction is distal to the biological container, and wherein the second direction is proximal to the biological container.

105. The apparatus of claim 100, wherein the pump is operably coupled to a sensor, wherein the sensor is couplable to a portion of the apparatus and configured to detect a speed of the apparatus relative to the field.

106. The apparatus of claim 105, wherein the controller is further configured to:
determine that the speed of the apparatus relative to the field exceeds a threshold value relative to the pressure level for actuating the pump; and
generate a notification prompting a user to reduce a speed of the planting assembly from (i) the speed of the apparatus relative to the field to (ii) the determined speed at which to move the planting assembly in the field.

107. The apparatus of any one of claims 105-106, wherein the sensor is an accelerometer.

108. The apparatus of any one of claims 99-107, wherein the local power source is a rechargeable battery.

109. The apparatus of any one of claims 99-108, wherein the switch is actuated using a key fob.

110. The apparatus of any one of claims 99-109, wherein the switch is wireless.

111. The apparatus of any one of claims 99-110, wherein the mounting mechanism is configured to hang over a railing of the planting assembly.

112. The apparatus of any one of claims 99-111, further comprising a universal mount couplable to the planting assembly and configured to couple the mounting mechanism of the apparatus to the planting assembly.

113. A method for installing a fluid dispensing apparatus to a planting assembly, the method comprising:
charging a local power source of the apparatus;
mounting the apparatus to a portion of the planting assembly, wherein the apparatus includes a mounting mechanism that is couplable to the planting assembly;
coupling first ends of a plurality of hoses to a plurality of one-way valves, wherein the plurality of one-way valves are configured to the mounting mechanism;
coupling second ends opposite the first ends of the plurality of hoses to a plurality of supply lines of the planting assembly;
filling a biological container of the apparatus with a biological product; and
actuating a switch of the apparatus, wherein actuating the switch causes a pump of the apparatus to subject contents from within the biological container to flow from the biological container, through (i) the plurality of one-way valves and (ii) the plurality of hoses, and into the supply lines of the planting assembly.

114. The method of claim 113, wherein mounting the apparatus to a portion of the planting assembly comprises hanging the apparatus over a rail of the planting assembly.

115. The method of any one of claims 113-114, wherein charging a local power source comprises at least one of charging a rechargeable battery and charging one or more solar panels.

116. The method of any one of claims 113-115, further comprising coupling the first ends of the plurality of hoses to a subset of the plurality of one-way valves, wherein the subset of the plurality of one-way valves corresponds to a quantity of the supply lines of the planting assembly.

117. The method of any one of claims 113-116, wherein actuating a switch comprises swiping a key fob over the switch, wherein the switch is couplable to a portion of the apparatus.
